(19) United States
(12) Patent Application Publication
(10) Pub. No.: US 2025/0096417 A1
(43) Pub. Date: Mar. 20, 2025

(54) SURFACE TREATMENT OF SOLID-STATE ION CONDUCTORS

(71) Applicant: QUANTUMSCAPE BATTERY, INC., San Jose, CA (US)

(72) Inventors: Aram YANG, San Jose, CA (US); Daven Somabhai MISTRY, San Jose, CA (US); Nicholas NDIEGE, San Jose, CA (US); Shawna SMITH, San Jose, CA (US); Thomas ARNOLD, San Jose, CA (US)

(21) Appl. No.: 18/970,447

(22) Filed: Dec. 5, 2024

Related U.S. Application Data
(63) Continuation of application No. PCT/US2023/027835, filed on Jul. 14, 2023.
(60) Provisional application No. 63/389,178, filed on Jul. 14, 2022.

(51) Int. Cl. H01M 50/449; H01M 10/0525; H01M 10/0562; H01M 50/403; H01M 50/434

(52) U.S. Cl. CPC H01M 50/449; H01M 10/0562; H01M 50/403; H01M 50/434; H01M 10/0525; H01M 2300/0077

(57) ABSTRACT

The present disclosure concerns the removal of various species from the surface of films and bilayers comprising inorganic material.

### CROSS-REFERENCE TO RELATED APPLICATION

This application claims priority to, and the benefit, of U.S. Ser. No. 63/389,178 filed Jul. 14, 2022, the contents of which are incorporated in their entirety for all purposes.

### FIELD

The present disclosure concerns the removal of various species from the surface of films comprising inorganic material.

### BACKGROUND

In a rechargeable Li ion battery, Li⁺ ions move from a negative electrode to a positive electrode during discharge and in the opposite direction during charge. An electrolyte physically separates and electrically insulates the positive and negative electrodes while also providing a medium for Li⁺ ions to conduct between the electrodes. The electrolyte ensures that electrons, produced when Li metal oxidizes at the negative electrode during discharge of battery (e.g., Li↔Li⁺+e⁻), conduct between the electrodes by way of an external and parallel electrical pathway to the pathway taken by the Li⁺ ions. If Li⁺ ions and electrons recombine, as can happen when they share a conduction path, before both conduct separately from the negative to the positive electrode, no useful work is captured and Li dendrites may form and lead to thermal runaway. In some electrochemical devices, electrolytes may be used in combination with, or intimately mixed with, cathode (i.e., positive electrode) active materials to facilitate the conduction of Li⁺ ions within the cathode region, for example, from the electrolyte-cathode interface and into and/or with the cathode active material.

Solid state ion-conducting ceramics, such as lithium-stuffed garnet oxide materials, are often used as electrolyte separators in a variety of electrochemical devices, including Li⁺ ion rechargeable batteries. Solid state lithium-stuffed garnet electrolyte membranes and separators, in particular, are well suited for electrochemical devices because of their high Li⁺ ion conductivity, their electric insulating properties, as well as their chemical compatibility with Li metal anodes (i.e., negative electrodes). Moreover, solid state lithium-stuffed garnet electrolyte membranes can be prepared as thin films, which are thinner and lighter than conventional electrolyte separators. See, for example, US Patent Application Publication No. 2015/0099190, published Apr. 9, 2015, and filed Oct. 7, 2014, entitled GARNET MATERIALS FOR LI SECONDARY BATTERIES AND METHODS OF MAKING AND USING GARNET MATERIALS, the entire contents of which are incorporated by reference in its entirety for all purposes. When these thinner and lighter lithium-stuffed garnet separators are incorporated into electrochemical cells, the resulting electrochemical cells are thought to achieve higher volumetric and gravimetric energy densities because of the volume and weight reduction afforded by the solid state separators.

Over time and in certain circumstances, lithium-containing species, for example, Li₂CO₃, can grow on the surface and/or interface of the solid lithium-stuffed garnet, which can contribute to interfacial resistance and/or impedance and poor cycling performance. Previously, researchers mechanically processed lithium-stuffed garnet electrolytes to remove secondary phases from its surfaces. These techniques included sanding or polishing the electrolyte surfaces to physically remove surface contaminants. However, these mechanical processing techniques are cost-prohibitive for high volume production, tend to be destructive to the material being processed, and tend not to prevent the formation of new surface contaminants or otherwise stabilize the mechanically polished surface. Temperature annealing methods in inert or reducing atmospheres for removing surface species are also described in U.S. Pat. No. 9,966,630, granted May 8, 2015, and filed Jan. 27, 2016, entitled ANNEALED GARNET ELECTROLYTE SEPARATORS, the entire contents of which are incorporated by reference in its entirety for all purposes.

There is therefore a need for improved processes for removing, mitigating, or preventing lithium-containing species from the surface of lithium-stuffed garnet films that help to improve the electrochemical performance and mitigate resistance and/or impedance of the film. The instant disclosure sets forth such processes for removing lithium-containing species from the surface of solid lithium-stuffed garnet films and intermediates in the process.

### SUMMARY

In one aspect, the present disclosure provides processes for surface-treating a lithium-stuffed garnet film or bilayer by removing or mitigating surface lithium-containing species and/or preventing their formation. These lithium-containing species include, for example, lithium carbonate, lithium hydroxide, lithium oxide, lithium peroxide, a hydrate thereof, an oxide thereof, or a combination thereof. The surface treatment process is selected from one of more processes comprising 1) irradiating the lithium-stuffed garnet film or bilayer with UV-light in an inert or reducing atmosphere and low oxygen atmosphere; 2) heating the lithium-stuffed garnet film or bilayer in an inert or reducing atmosphere in proximity to graphite; and 3) heating and contacting the lithium-stuffed garnet film or bilayer with plasma in an inert or reducing atmosphere for less than ten minutes. In certain embodiments, these surface-treatment processes result in lithium-stuffed garnet films or bilayers with low impedance and/or resistance.

Additionally, it has been surprisingly discovered that in certain embodiments, the removal of surface lithium-containing species from lithium-stuffed garnet films using a surface-treatment described herein, enables a fast charge of the resulting lithium battery, for example a 0-80% charge in under 15 minutes. Therefore, another aspect of the present invention is a solid-state lithium battery that comprises 1) cathode active material; 2) a lithium-stuffed garnet film treated with a surface-treatment process described herein; and 3) an anode active material wherein the solid-state battery can be charged from about 0-80% in under about 15 minutes.

In another aspect, the present disclosure provides intermediates for the surface-treatment processes described herein. For example, during the surface-treatment with plasma, the lithium-stuffed garnet film is first contacted with plasma to remove lithium-containing species and is then rapidly heat-treated to remove implanted gas on the surface of the film that forms as a result of the contact with plasma. Therefore, the present disclosure provides a lithium-stuffed garnet film wherein the surface of the film comprises a gas as detected by x-ray photo-electron spectroscopy (XPS) or Fourier-transformed-infrared-red spectroscopy (FT-IR). In one embodiment, the gas is selected from argon, hydrogen, nitrogen, or a mixture thereof. In one embodiment, the gas is argon.

### BRIEF DESCRIPTIONS OF THE DRAWINGS

FIG. 1 is a schematic of the layer-by-layer stacking of graphite and lithium-stuffed garnet films for the surface-treatment in the proximity of graphite as described, for example, in Example 1.

FIG. 2 is an XPS (x-ray photoelectron spectroscopy) plot comparing the intensity of carbonate peaks on the surface of an LLZO-based film that has been annealed with graphite to an LLZO-based film that has only been sintered as described in Example 1.

FIG. 3A is an optical image of a LLZO-based film annealed without a reducing environment (not in the proximity of graphite, but heat-treated) as described in Example 1. NiO was observed and the corners of the film were misshapen and curved.

FIG. 3B is an optical image of a LLZO-based film annealed with a reducing environment (in the proximity of graphite) as described in Example 1. In contrast to FIG. 4A, NiO was not observed and the integrity of the film shape was observed.

FIG. 4 is a graph plotting the charge transfer resistance (R₂) for an electrochemical cell containing a film that was annealed using graphite and an electrochemical cell containing a film that was only sintered and not annealed as described in Example 2.

FIG. 5 is a graph plotting the percent charge relative to the run time for a battery containing a film that was annealed in proximity to graphite as described in Example 3.

FIG. 6 is the temperature profile for the rapid thermal annealing following the plasma etching as described in Example 5 at 200° C., 300° C., 400° C., 500° C., and 600° C.

FIG. 7 is a graph showing the removal of implanted argon after rapid thermal annealing as determined by XPS at a temperature of 600° C. as described in Example 4. The control was no plasma etching. The removal of implanted argon for a film that was only plasma etched and not thermal annealed is also shown (plasma etched).

FIG. 8A is a graph showing the amount of surface carbonate as measured by XPS for the films after plasma etching and thermal annealing at temperatures ranging from 200° C. to 600° C. as described in Example 4. The amount of surface carbonate for a film that was only plasma etched and not thermal annealed is also shown. The control was no plasma etching.

FIG. 8B is a magnification of the dotted box of FIG. 8A showing only atom counts/Zr of less than 3.0.

FIG. 9 is a graph plotting the surface carbonate as measured by XPS for the films after plasma etching and thermal annealing at temperatures ranging from 200° C. to 600° C. as described in Example 4. This is compared to the expected values for films that have only been sintered and not annealed.

FIG. 10 is an EIS Nyquist plot comparing the resistance of films subjected to plasma etching and thermal annealing at temperatures ranging from 200° C. to 600° C. as described in Example 5. The magnification is of the dotted circle and shows the resistance of the film annealed at 600° C. compared to the control. The control was no plasma etching.

FIG. 11 is a one-way analysis comparing the surface carbonate measured by XPS of the control film and films after UV-treatment for 3, 6, and 10 minutes as described in Example 6.

FIG. 12A is a one-way analysis comparing the surface carbonate measured by XPS of the control film and a film after UV-treatment for 72 minutes via a UV reflective chamber as described in Example 7.

FIG. 12B is an XPS plot comparing the intensity of the carbonate peaks and the adventitious carbon peaks for the control film and the film treated with UV-light for 72 minutes as described in Example 7.

FIG. 13 is a graph of the amount of oxygen relative to the purge N₂ flow rate during the UV-treatment. XPS results of residual garnet surface carbonate from films cleaned in a separate experiment at the flow rates analyzed were overlaid.

FIG. 14 is a one-way analysis comparing the surface carbonate measured by XPS of a control bilayer and a bilayer after UV-treatment.

FIG. 15A is a graph comparing the charge ASR of films exposed to UV-light at a conveyer speed of 2.5 mm/second (at various UV-lamp powers) and a film exposed to UV-light at a conveyer speed of 5.6 mm/second.

FIG. 15B is a graph comparing the discharge ASR of films exposed to UV-light at a conveyer speed of 2.5 mm/second (at various UV-lamp powers) and a film exposed to UV-light at a conveyer speed of 5.6 mm/second.

### DETAILED DESCRIPTION

Solid state electrolytes, including lithium-stuffed garnet films and bilayers, possess a host of advantages, however, it has been discovered that when exposed to atmospheric conditions, lithium-containing species, for example, Li₂CO₃, can grow on the surface of the solid lithium-stuffed garnet and/or interface with other materials. This can contribute to interfacial resistance and/or impedance and poor cycling performance (See, for example, Sharafi, Asma, et al. Journal of Power Sources 302 (2016) 135-139. See, for example, Cheng, L., et al., “Interrelationships among Grain Size, Surface Composition, Air Stability, and Interfacial Resistance of Al-Substituted Li₇La₃Zr₂O₁₂ Solid Electrolytes,” ACS Appl. Mater. Interfaces, 2015, 7 (32), pp 17649-17655, DOI: 10.1021/acsami.5b02528; Cheng, L., et al., ACS Appl. Mater. Interfaces, 2015, 7 (3), pp 2073-2081, DOI: 10.1021/am508111r, doi/abs/10.1021/am508111r; and Cheng, L., et al., Phys. Chem. Chem. Phys., 2014, 16, 18294-18300, DOI: 10.1039/C4CP02921F).

Therefore, there exists a need for improvements in the chemistry, processing and engineering of these lithium-stuffed garnet films and their surfaces and interfaces with lithium metal in order to make them more commercially viable for use in electrochemical cells. It has been surprisingly discovered that by surface-treating lithium-stuffed garnet films with a process described herein that uses graphite, UV-light, plasma, or a combination thereof, the resulting films exhibit low impedance and/or resistance. Furthermore, in certain embodiments, the surface-treated lithium-stuffed garnet film enables a “fast” charge of 0-80% in under 15 minutes of the resulting battery.

### I. Definitions

As used herein, the term “about,” when qualifying a number, e.g., 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C. For example, evaporating a solvent at about 80° C. includes evaporating a solvent at 79° C., 80° C., or 81° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrases “electrochemical cell” or “battery cell” shall mean a single cell including a positive electrode and a negative electrode, which have ionic communication between the two using an electrolyte. In some embodiments, the same battery cell includes multiple positive electrodes and/or multiple negative electrodes enclosed in one container.

As used herein, the term “surface” refers to material that is near or at an interface between two different phases, chemicals, or states of matter. For example, a separator, including but not limited to, a thin film garnet membrane, when exposed to air has a surface described by the periphery or outside portion of the membrane or separator which contacts the air. For rectangular-shaped film membranes or separators, there is a top and a bottom surface which both individually have higher surface areas than each of the four side surfaces individually. In this rectangular membrane or separator example, there are also four side surfaces which have surface areas less than either or both of the top and bottom surfaces. For disc-shaped film membranes or separators, there is a top and a bottom surface which both individually have higher surface areas than the circumference-side of the disc. When used as an electrolyte membrane or separator in an electrochemical cell, the top or bottom surface is the side or part of the membrane or separator which contacts the negative electrode (i.e., Li metal), which contacts the positive electrode (i.e., cathode or catholyte in cathode), and/or which contacts a layer or bonding agent disposed between the membrane or separator and the positive electrode. A surface has larger x- and y-axis physical dimensions than it does z-axis physical dimensions, wherein the z-axis is the axis perpendicular to the surface. The depth or thickness of a surface can be of molecular order of magnitude or up to 1 micron. Film surfaces can include dangling bonds, excess hydroxyl groups, bridging oxides, or a variety of other species which result in the film surface having a chemical composition that may be stoichiometrically different from the bulk. As used herein, the term “bulk,” refers to a portion or part of the film that is extended in space in three-dimensions by at least 1 micron. The bulk refers to the portion or part of a material which is exclusive of its surface, as defined above.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

As used herein, a “catholyte” or “cathode active material” refers to an ion conductor that is intimately mixed with, or that surrounds, or that contacts the positive electrode active material. Catholytes suitable with the embodiments described herein include, but are not limited to, catholytes having the common name LPS, LXPS, LXPSO, where X is Si, Ge, Sn, As, Al, LATS, or also Li-stuffed garnets, or combinations thereof, and the like. Catholytes may also be liquid, gel, semi-liquid, semi-solid, polymer, and/or solid polymer ion conductors known in the art. Catholytes include those catholytes set forth in US Patent Application Publication No. 2015-0171465, which published on Jun. 18, 2015, entitled SOLID STATE CATHOLYTE OR ELECTROLYTE FOR BATTERY USING Li_{A}MP_{B}S_{C} (M=Si, Ge, AND/OR Sn), filed May 15, 2014, the contents of which are incorporated by reference in their entirety. Catholytes include those catholytes set forth in US Patent Application Publication No. 2015/0099190, published on Apr. 9, 2015, entitled GARNET MATERIALS FOR LI SECONDARY BATTERIES AND METHODS OF MAKING AND USING GARNET MATERIALS, and filed Oct. 7, 2014, the contents of which are incorporated by reference in their entirety.

As used herein, the phrase “solid state catholyte,” or the term “catholyte” refers to an ion conductor that is intimately mixed with, or surrounded by, a cathode (i.e., positive electrode) active material (e.g., a metal fluoride optionally including lithium).

In some examples the catholyte may include a gel electrolyte such as, but not limited to, the electrolyte compositions set forth in U.S. Pat. No. 5,296,318, entitled RECHARGEABLE LITHIUM INTERCALATION BATTERY WITH HYBRID POLYMERIC ELECTROLYTE; also U.S. Pat. No. 5,460,904; also U.S. Pat. No. 5,456,000, to Gozdz, et al., or those compositions set forth in US Patent Application No. 20020192561, entitled SEPARATORS FOR WINDING-TYPE LITHIUM SECONDARY BATTERIES HAVING GEL-TYPE POLYMER ELECTROLYTES AND MANUFACTURING METHOD FOR THE SAME, which published Dec. 19, 2002.

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer which is laminated to a positive or negative electrode. During charging and discharging, electrons move in the opposite direction to the flow of Li ions and pass through the current collector when entering or exiting an electrode.

As used herein, the term “electrolyte,” refers to a material that allows ions, e.g., Li⁺, to migrate therethrough, but which does not allow electrons to conduct therethrough. Electrolytes are useful for electrically isolating the cathode and anodes of a secondary battery while allowing ions, e.g., Li⁺, to transmit through the electrolyte. Electrolytes are ionically conductive and electrically insulating material. Electrolytes are useful for electrically insulating the positive and negative electrodes of a secondary battery while allowing for the conduction of ions, e.g., Li⁺, through the electrolyte.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

As used herein the phrase “free-standing thin film,” refers to a film that is not adhered or supported by an underlying substrate. In some examples, free-standing thin film is a film that is self-supporting, which can be mechanically manipulated or moved without need of substrate adhered or fixed thereto.

As used herein, the molar ratios, unless specified to the contrary, describe the ratio of constituent elements as batched in the reaction used to make the described material.

As used herein, a “thickness” by which is film is characterized refers to the distance, or median measured distance, between the top and bottom faces of a film. As used herein, the top and bottom faces refer to the sides of the film having the largest surface areas.

As used herein, electrolyte separator or membrane thickness is measured by cross-sectional scanning electron microscopy.

As used herein the phrase “active electrode material,” or “active material,” refers to a material that is suitable for use as a Li rechargeable battery and which undergoes a chemical reaction during the charging and discharging cycles. For example, an “active cathode material,” includes a metal fluoride that converts to a metal and lithium fluoride during the discharge cycle of a Li rechargeable battery.

As used herein the phrase “active anode material” refers to an anode material that is suitable for use in a Li rechargeable battery that includes an active cathode material as defined above. In some examples, the active material is Lithium metal. In some of the methods set forth herein, the sintering temperatures are high enough to melt the Lithium metal used as the active anode material.

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer which is laminated to a positive or negative electrode. During charging and discharging, electrons move in the opposite direction to the flow of Li ions and pass through the current collector when entering or exiting an electrode.

As used herein, the phrase “green film” refers to an unsintered film including at least one member selected from garnet materials, precursors to garnet materials, calcined garnet materials, binder, solvent, carbon, dispersant, or combinations thereof.

As used herein the phrase “providing an unsintered thin film,” refers to the provision of, generation or, presentation of, or delivery of an unsintered thin film or a green film defined above. For example, providing an unsintered thin film refers to the process of making an unsintered thin film available, or delivering an unsintered thin film, such that the unsintered thin film can be used as set forth in a method described herein.

As used herein the phrase “unsintered thin film,” refers to a thin film, including the components and materials described herein, but which is not sintered by a sintering method set forth herein. Thin refers, for example, to a film that has an average thickness dimensions of about 10 nm to about 100 μm. In some examples, thin refers to a film that is less than about 1 μm, 10 μm or 50 μm in thickness.

As used herein the term “making,” refers to the process or method of forming or causing to form the object that is made. For example, making an energy storage electrode includes the process, process steps, or method of causing the electrode of an energy storage device to be formed. The end result of the steps constituting the making of the energy storage electrode is the production of a material that is functional as an electrode.

As used herein the phrase “energy storage electrode,” refers to, for example, an electrode that is suitable for use in an energy storage device, e.g., a lithium rechargeable battery or Li-secondary battery. As used herein, such an electrode is capable of conducting electrons and Li ions as necessary for the charging and discharging of a rechargeable battery.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃↔3LiF+Fe.

As used herein, the phrase “providing” refers to the provision of, generation or, presentation of, or delivery of that which is provided.

As used herein, the terms “separator” refers to a solid electrolyte which conducts Li⁺ ions, is substantially insulating to electrons, and is suitable for use as a physical barrier or spacer between the positive and negative electrodes in an electrochemical cell or a rechargeable battery. A separator, as used herein, is substantially insulating to electrons when the separator's lithium ion conductivity is at least 10³ times, and typically 10⁶ times, greater than the separator's electron conductivity. Unless explicitly specified to the contrary, a separator as used herein is stable when in contact with lithium metal. In one embodiment, the separator is a thin film garnet separator, for example, a lithium-stuffed garnet thin film. In one embodiment, the separator is a bare film, a CSC (co-sintered current collector) film, or a film-on-foil film.

As used herein, a “CSC film” is a thin film comprising a sintered metal oxide with a co-sintered layer of metal (the CSC or “cosintered” layer). A CSC film also includes a mixture of a metal oxide and a metal co-sintered together. In the mixture, the metal may be particles of metal mixed with the metal oxide. In certain embodiments, the CSC layer may comprise Ni in 0.0001-25% by weight, Fe in 1-25% by weight, or combinations thereof and the remainder is lithium-stuffed garnet. In some cases, the CSC layer comprises 1-20 weight % of Ni and 1-10 weight % of Fe and the remainder is lithium-stuffed garnet. In some cases, the CSC layer comprises 5-15 weight % of Ni and 1-5 weight % of Fe and the remainder is lithium-stuffed garnet. In some cases, the CSC layer comprises 10-15 weight % of Ni and 3-5 weight % of Fe and the remainder is lithium-stuffed garnet.

As used herein, the phrase “lithium stuffed garnet” refers to films that are characterized by a crystal structure related to a garnet crystal structure. Lithium-stuffed garnets include compounds having the formula Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2, 10<F<13, and M′ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, Ta, V, W, Mo, or Sb and as described herein. Garnets, as used herein, also include those garnets described above that are doped with Al₂O₃. Garnets, as used herein, also include those garnets described above that are doped so that Al³⁺ substitutes for Li⁺. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (t1+t2+t3=subscript 2) so that the La:(Zr/Nb/Ta) ratio is 3:2. Also, garnet used herein includes, but is not limited to, LiₓLa₃Zr₂O₁₂+yAl₂O₃, wherein x ranges from 5.5 to 9; and y ranges from 0 to 1. In some examples x is 7 and y is 1.0. In some examples x is 7 and y is 0.35. In some examples x is 7 and y is 0.7. In some examples x is 7 and y is 0.4. Also, garnets as used herein include, but are not limited to, LiₓLa₃Zr₂O₁₂+yAl₂O₃.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the term “LZO” or “LLZO” refers to Li₂ZrO₃, ZrO₂, or a combination thereof.

As used herein, the phrase “garnet precursor chemicals” or “chemical precursor to a Garnet-type electrolyte” refers to chemicals which react to form a lithium stuffed garnet material described herein. These chemical precursors include, but are not limited to lithium hydroxide (e.g., LiOH), lithium oxide (e.g., Li₂O), lithium carbonate (e.g., Li₂CO₃), zirconium oxide (e.g., ZrO₂), lanthanum oxide (e.g., La₂O₃), aluminum oxide (e.g., Al₂O₃), aluminum (e.g., Al), aluminum nitrate (e.g., AlNO₃), aluminum nitrate nonahydrate, niobium oxide (e.g., Nb₂O₅), tantalum oxide (e.g., Ta₂O₅).

A “bilayer” herein includes a ceramic layer deposited onto a metal layer. A sintered bilayer may have a ceramic layer thickness of 10-50 μm and the metal layer thickness is 2-20 μm thick. The bilayer may have a ceramic layer thickness of 20-30 μm and the metal layer thickness is 3-10 μm thick.

As used herein the phrase “garnet-type electrolyte,” refers to an electrolyte that includes a garnet or lithium stuffed garnet material described herein as the ionic conductor.

As used herein, the phrase “doped with alumina” means that Al₂O₃ is used to replace certain components of another material, e.g., a garnet. A lithium stuffed garnet that is doped with Al₂O₃ refers to garnet wherein aluminum (Al) substitutes for an element in the lithium stuffed garnet chemical formula, which may be, for example, Li or Zr.

As used herein, the phrase “high conductivity,” refers to a conductivity, such as ionic conductivity, that is greater than 10⁻⁵ S/cm at room temperature. In some examples, high conductivity includes a conductivity greater than 10⁻⁵ S/cm at room temperature.

As used herein, the phrase “Zr is partially replaced by a higher valence species” refers to the substitution of Zr⁴⁺ with a species that has, for example, a 5⁺ or 6⁺ charge. For example, if some Nb⁵⁺ can reside in a lattice position in a garnet crystal structure where a Zr atom resides and in doing so substitute for Zr⁴⁺, then Zr is partially replaced by Nb. This is also referred to as niobium doping.

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂·0.35Al₂O₃).

As used herein the phrase “casting a film,” refers to the process of delivering or transferring a liquid or a slurry into a mold, or onto a substrate, such that the liquid or the slurry forms, or is formed into, a film. Casting may be done via doctor blade, meyer rod, comma coater, gravure coater, microgravure, reverse comma coater, slot dye, slip and/or tape casting, and other methods known to those skilled in the art.

As used herein the phrase “composite electrode,” refers to an electrode that is composed of more than one material. For example, a composite electrode may include, but is not limited to, an active cathode material and a garnet-type electrolyte in intimate mixture or ordered layers or wherein the active material and the electrolyte are interdigitated.

As used herein the phrase “plasma etching” the removal of lithium-carbonate species from the surface of a lithium-stuffed garnet film using plasma created by exciting ions in an inert atmosphere, for example, argon, nitrogen, hydrogen, or a mixture thereof.

As used herein, the term “XPS” refers to X-ray photoelectron spectroscopy, a surface-sensitive quantitative spectroscopic technique that measures the elemental composition at the parts per thousand range. XPS is useful for determining the empirical formula of an analyzed species. XPS is useful for determining the chemical state and electronic state of the elements that exist within a material.

As used herein, the term “ASR” refers to area specific resistance. As used herein, the phrase “lithium interfacial resistance” refers to the interfacial resistance of a material towards the incorporation or conduction of Li⁺ ions. A lithium interfacial ASR (ASR_{interface}) is calculated from the interfacial resistance (R_{interface}) via ASR_{interface}=R_{interface}*A/2 where A is the area of the electrodes in contact with the separator and the factor of 2 accounts for 2 interfaces, assuming the cell is symmetric.

As used herein, area-specific resistance (ASR) is measured by electrochemical cycling using an Arbin or Biologic instrument unless otherwise specified to the contrary. ASR may be measured using electrochemical impedance spectroscopy (EIS). EIS can be performed on a Biologic VMP3 instrument or an equivalent thereof. In an example ASR measurement, lithium contacts are deposited on two sides of a sample. An AC voltage of 25 mV rms is applied across a frequency of 300 kHz-0.1 mHz while the current is measured.

### II. Surface-Treatment of Lithium-Stuffed Garnet Films

The present disclosure provides processes for the surface-treatment of lithium-stuffed garnet films or bilayers to remove or mitigate lithium-containing species from the surface of the films or bilayers. The removal of these lithium-containing species, for example, lithium carbonate, lithium hydroxide, lithium oxide, lithium peroxide, a hydrate thereof, an oxide thereof, or a combination thereof, results in films or bilayers with low impedance and/or resistance, and in certain embodiments, the surface-treated film helps to enable a fast charge of the resulting lithium battery.

As described herein, the surface-treatment is one or more processes selected from a treatment comprising 1) irradiating the lithium-stuffed garnet film or bilayer with UV-light in an inert or reducing atmosphere and low oxygen atmosphere; 2) heating the lithium-stuffed garnet film or bilayer in an inert or reducing atmosphere in proximity to graphite; or 3) heating and contacting the lithium-containing film or bilayer with plasma in an inert or reducing atmosphere for less than ten minutes.

Also described herein is a method of surface-treating a film or bilayer comprising a process described herein wherein the carbonate on the surface of the film or bilayer is greater than about 50 atom counts/zirconium prior to the surface treatment and wherein the carbonate on the surface of the film or bilayer is less than about 10 atom counts/zirconium after the surface treatment. In certain embodiments, the surface carbonate is greater than about 60 atom counts/zirconium prior to the surface treatment and less than about 10 atom counts/zirconium after the surface treatment. In certain embodiments, the surface carbonate is greater than about 70 atom counts/zirconium prior to the surface treatment and less than about 10 atom counts/zirconium after the surface treatment. In certain embodiments, the surface carbonate is greater than about 80 atom counts/zirconium prior to the surface treatment and less than about 10 atom counts/zirconium after the surface treatment. In certain embodiments, the surface carbonate is greater than about 90 atom counts/zirconium prior to the surface treatment and less than about 10 atom counts/zirconium after the surface treatment. In certain embodiments, the surface carbonate is greater than about 100 atom counts/zirconium prior to the surface treatment and less than about 10 atom counts/zirconium after the surface treatment.

In certain embodiments, the surface carbonate is greater than about 100 atom counts/zirconium prior to the surface treatment and less than about 20 atom counts/zirconium after the surface treatment. In certain embodiments, the surface carbonate is greater than about 100 atom counts/zirconium prior to the surface treatment and less than about 30 atom counts/zirconium after the surface treatment. In certain embodiments, the surface carbonate is greater than about 100 atom counts/zirconium prior to the surface treatment and less than about 40 atom counts/zirconium after the surface treatment. In certain embodiments, the surface carbonate is greater than about 100 atom counts/zirconium prior to the surface treatment and less than about 50 atom counts/zirconium after the surface treatment.

In certain embodiments, the surface carbonate is greater than about 90 atom counts/zirconium prior to the surface treatment and less than about 20 atom counts/zirconium after the surface treatment. In certain embodiments, the surface carbonate is greater than about 90 atom counts/zirconium prior to the surface treatment and less than about 30 atom counts/zirconium after the surface treatment. In certain embodiments, the surface carbonate is greater than about 90 atom counts/zirconium prior to the surface treatment and less than about 40 atom counts/zirconium after the surface treatment. In certain embodiments, the surface carbonate is greater than about 90 atom counts/zirconium prior to the surface treatment and less than about 50 atom counts/zirconium after the surface treatment.

In certain embodiments, the surface carbonate is greater than about 80 atom counts/zirconium prior to the surface treatment and less than about 20 atom counts/zirconium after the surface treatment. In certain embodiments, the surface carbonate is greater than about 80 atom counts/zirconium prior to the surface treatment and less than about 30 atom counts/zirconium after the surface treatment. In certain embodiments, the surface carbonate is greater than about 80 atom counts/zirconium prior to the surface treatment and less than about 40 atom counts/zirconium after the surface treatment. In certain embodiments, the surface carbonate is greater than about 80 atom counts/zirconium prior to the surface treatment and less than about 50 atom counts/zirconium after the surface treatment.

In certain embodiments, the surface carbonate is greater than about 70 atom counts/zirconium prior to the surface treatment and less than about 20 atom counts/zirconium after the surface treatment. In certain embodiments, the surface carbonate is greater than about 70 atom counts/zirconium prior to the surface treatment and less than about 30 atom counts/zirconium after the surface treatment. In certain embodiments, the surface carbonate is greater than 7 about 0 atom counts/zirconium prior to the surface treatment and less than about 40 atom counts/zirconium after the surface treatment. In certain embodiments, the surface carbonate is greater than about 70 atom counts/zirconium prior to the surface treatment and less than about 50 atom counts/zirconium after the surface treatment.

In certain embodiments, the surface carbonate is greater than about 50 atom counts/zirconium prior to the surface treatment and less than about 20 atom counts/zirconium after the surface treatment. In certain embodiments, the surface carbonate is greater than about 50 atom counts/zirconium prior to the surface treatment and less than about 30 atom counts/zirconium after the surface treatment. In certain embodiments, the surface carbonate is greater than about 50 atom counts/zirconium prior to the surface treatment and less than about 40 atom counts/zirconium after the surface treatment.

In certain embodiments, following a surface-treatment described herein, the lithium-stuffed garnet film or bilayer is characterized by a chemical formula different from the surfaces of the lithium-stuffed garnet film or bilayer.

In certain embodiments, a surface-treatment described herein affords a film or bilayer wherein the surface of the film or bilayer is characterized as having a layer thereupon, greater than 1 nm and less than 1 μm, comprising lithium carbonate, lithium hydroxide, lithium oxide, lithium peroxide, a hydrate thereof, an oxide thereof, or a combination thereof as measured by XPS or FT-IR. In certain embodiments, a surface-treatment described herein affords a film or bilayer wherein the surface of the film or bilayer is characterized as having less than about a 0.5 μm thick layer thereupon comprising lithium carbonate, lithium hydroxide, lithium oxide, lithium peroxide, a hydrate thereof, an oxide thereof, or a combination thereof as measured by XPS or FT-IR. In certain embodiments, a surface-treatment described herein affords a film or bilayer wherein the surface of the film or bilayer is characterized as having less than a 0.35 μm thick layer thereupon comprising a lithium carbonate, lithium hydroxide, lithium oxide, lithium peroxide, a hydrate thereof, an oxide thereof, or a combination thereof. In certain embodiments, a surface-treatment described herein affords a film or bilayer wherein the surface of the film or bilayer is characterized as having less than a 0.25 μm thick layer thereupon comprising a lithium carbonate, lithium hydroxide, lithium oxide, lithium peroxide, a hydrate thereof, an oxide thereof, or a combination thereof. In certain embodiments, a surface-treatment described herein affords a film or bilayer wherein the surface of the film or bilayer is characterized as having less than a 0.15 μm thick layer thereupon comprising a lithium carbonate, lithium hydroxide, lithium oxide, lithium peroxide, a hydrate thereof, an oxide thereof, or a combination thereof. In certain embodiments, a surface-treatment described herein affords a film or bilayer wherein the surface is characterized as having less than a 0.1 μm thick layer thereupon comprising a lithium carbonate, lithium hydroxide, lithium oxide, lithium peroxide, a hydrate thereof, an oxide thereof, or a combination thereof. In certain embodiments, a surface-treatment described herein affords a film or bilayer wherein the surface of the film or bilayer is characterized as having less than a 0.05 μm thick layer thereupon comprising a lithium carbonate, lithium hydroxide, lithium oxide, lithium peroxide, a hydrate thereof, an oxide thereof, or a combination thereof. In certain embodiments, a surface-treatment described herein affords a film or bilayer wherein the surface of the film or bilayer is characterized as having no detectable presence of lithium carbonate, lithium hydroxide, lithium oxide, lithium peroxide, or a combination thereof.

In some embodiments herein, the lithium carbonate is characterized by Liₓ(CO₃)_{y} and x is from 0 to 2, and y is from 0 to 1.

In some embodiments herein, the lithium hydroxide is characterized by Liₓ(OH)_{y} and x and y are each, independently, from 0 to 1.

In some embodiments herein, the lithium oxide is characterized by LiₓO_{y} and x and y are each, independently, from 0 to 2.

In alternative embodiments, a bare film, a CSC (co-sintered current collector) film, or a film-on-foil film is surface-treated as described herein.

### Surface-Treatment of Lithium-Stuffed Garnet Films in the Proximity of Graphite

In one embodiment, the present disclosure provides a process for surface-treating a lithium-stuffed garnet film or bilayer by removing or minimizing lithium carbonate, lithium hydroxide, lithium oxide, lithium peroxide, a hydrate thereof, an oxide thereof, or a combination thereof from the surface of the film wherein the process comprises heating the lithium-stuffed garnet film or bilayer in an inert or reducing atmosphere in proximity to a carbon source, for example, graphite. In another embodiment of the present disclosure, the process of surface-treating a lithium-stuffed garnet film or bilayer comprising heating the lithium-stuffed garnet film or bilayer in an inert or reducing atmosphere in proximity to graphite prevents the formation of lithium carbonate, lithium hydroxide, lithium oxide, lithium peroxide, a hydrate thereof, an oxide thereof, or a combination thereof that can occur under certain circumstances when the lithium-garnet film or bilayer undergoes thermal annealing.

In one embodiment, the lithium-stuffed garnet film or bilayer is heated in proximity to graphite at a temperature between about 500° C. to 900° C. In one embodiment, the lithium-stuffed garnet film or bilayer is heated in proximity to graphite at a temperature between about 700° C. to 900° C. In one embodiment, the lithium-stuffed garnet film or bilayer is heated in proximity to graphite at a temperature between about 750° C. to 850° C. In certain embodiments, the lithium-stuffed garnet film or bilayer is heated in proximity to graphite at a temperature that is at least about 500° C., at least about 600° C. at least about 700° C. at least about 750° C., at least about 800° C., or at least about 850° C.

In one embodiment, the lithium-stuffed garnet film or bilayer is heated in proximity to graphite for the minimal time necessary to melt only the surface of the film. In one embodiment, the lithium-stuffed garnet film or bilayer is heated in proximity to graphite for the minimal time necessary to sinter only the surface of the film. In certain embodiments, the lithium-stuffed garnet film or bilayer is heated in proximity to graphite for at least about 15 minutes, for at least about 30 minutes, for at least about 45 minutes, for at least about 60 minutes, for at least about 90 minutes, for at least about 120 minutes, for at least about 150 minutes, for at least about 180 minutes, or more. In certain embodiments, the lithium-stuffed garnet film or bilayer is heated in proximity to graphite for between about 45 minutes and 90 minutes. In one embodiment, the lithium-stuffed garnet film or bilayer is heated in proximity to graphite for about 60 minutes.

In one embodiment, the lithium-stuffed garnet film or bilayer is heated in proximity to graphite at a temperature between about 500° C. to 900° C. for about 60 minutes. In one embodiment, the lithium-stuffed garnet film or bilayer is heated in proximity to graphite at a temperature between about 750° C. to 850° C. for about 1 hour.

In one embodiment, the lithium-stuffed garnet film or bilayer is heated in proximity to graphite in an inert atmosphere selected from argon, nitrogen, hydrogen, or a mixture thereof. In one embodiment, the inert atmosphere is argon.

In one embodiment, the lithium-stuffed garnet film or bilayer is heated in proximity to graphite at a temperature between about 500° C. to 900° C. for about 60 minutes in an argon atmosphere. In one embodiment, the lithium-stuffed garnet film or bilayer is heated in proximity to graphite at a temperature between about 750° C. to 850° C. for about 1 hour in an argon atmosphere.

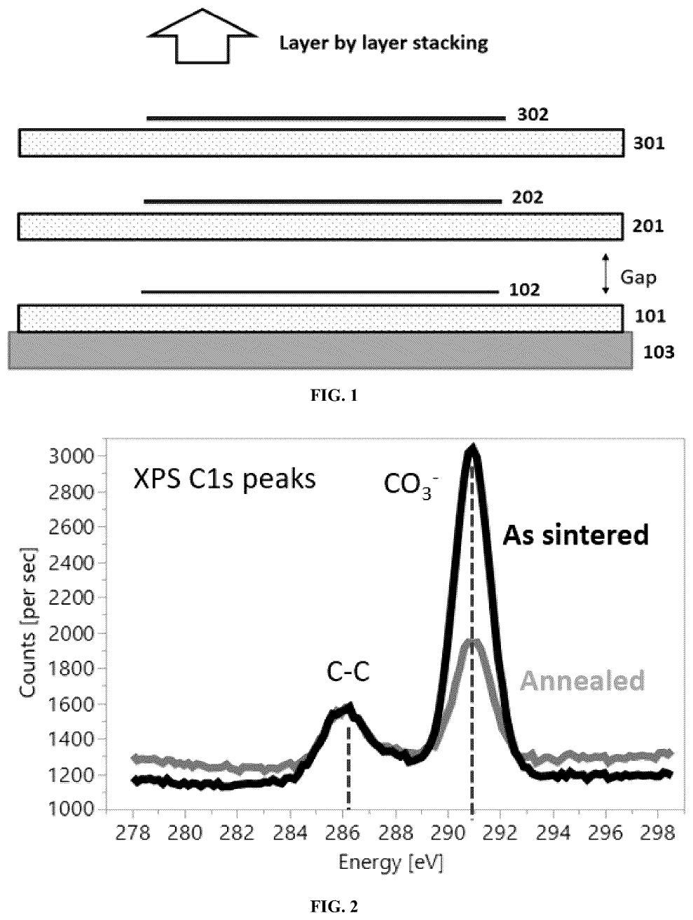

In certain embodiments, multiple lithium-stuffed garnet films or bilayers are surface-treated simultaneously by creating a layer stack arrangement of the carbon source, for example, graphite and lithium-stuffed garnet films or bilayers, as shown for example in FIG. 1. This layer stack arrangement comprises a plurality of layer stacks arranged one above the other wherein each layered stack comprises (1) a graphite plate and (2) a lithium-stuffed garnet film or bilayer in contact with the graphite wherein there is a gap between each layer of graphite. For example, as shown in FIG. 1, in one embodiment, this layer stack arrangement comprises a first layer of graphite 101 and a lithium-stuffed garnet film or bilayer 102 in contact with the graphite. This first layer is stacked on an alumina carrier plate 103. A second layer comprising graphite 201 and a lithium-stuffed garnet film or bilayer 202 and a third layer comprising graphite 301 and a lithium-stuffed garnet film or bilayer 302 can be stacked on top of the first layer to create a plurality of layers with a gap between each layer.

In one embodiment, the gap between each layer of graphite is between about 0.15 mm to 25 mm. In one embodiment the gap is between about 0.2 mm to 20 mm. In one embodiment the gap is between about 0.15 mm to 2 mm. In one embodiment the gap is between about 2 mm to 5 mm. In one embodiment the gap is between about 5 mm to 8 mm. In one embodiment the gap is between about 8 mm to 10 mm. In one embodiment the gap is between about 10 mm to 15 mm. In one embodiment the gap is between about 15 mm to 20 mm. In one embodiment the gap is between about 20 mm to 25 mm. In one embodiment the gap is about 1 mm.

In one embodiment, a space of at least about 50 mm is maintained between each lithium-stuffed garnet film or bilayer in the layer stack. In certain embodiments, a space of at least about 40 mm, 30 mm, 20 mm, or 10 mm is maintained between each lithium-stuffed garnet film or bilayer in the layer stack. In one embodiment, a space of about 10 mm is maintained between each lithium-stuffed garnet film or bilayer in the layer stack.

In certain embodiments, more than 5 layer stack arrangements are stacked together to form the layer stack arrangement. In certain embodiments, more than 10, more than 15, more than 20, more than 25, more than 30, more than 40, more than 50, or more layer stack arrangements are stacked together to form the layer stack arrangement. In certain embodiments, more than 50, more than 75, more than 100, more than 125, more than 150, more than 200, more than 250, more than 300, more than 350, more than 400, or more layer stack arrangements are stacked together to form the layer stack arrangement. In one embodiment, the first graphite layer of the layer stack arrangement is stacked on top of an alumina carrier plate in a tube furnace or kiln, for example a batch kiln, for the surface-treatment. Non-limiting examples of furnaces and kilns include a roller hearth kiln (RHK), a gas carburizing furnace (GCF), or a roll-to-roll heating furnace.

In another embodiment, the present disclosure provides a process for surface-treating a lithium-stuffed garnet film or bilayer in the layer stack arrangement described herein by removing or minimizing lithium carbonate, lithium hydroxide, lithium oxide, lithium peroxide, a hydrate thereof, an oxide thereof, or a combination thereof from the surface of the film or bilayer wherein the process comprises heating the layer stack arrangement in an inert or reducing atmosphere in proximity to graphite using the conditions as described herein.

### Surface-Treatment of Lithium-Stuffed Garnet Using Plasma

In one embodiment, the present disclosure provides a process for surface-treating a lithium-stuffed garnet film or bilayer by removing or minimizing lithium carbonate, lithium hydroxide, lithium oxide, lithium peroxide, a hydrate thereof, an oxide thereof, or a combination thereof from the surface of the film or bilayer wherein the process comprises (a) contacting the film or bilayer with plasma in the presence of a reducing or inert atmosphere for less than about 10 minutes; and (b) heating the film or bilayer for less than about 10 minutes in the reducing or inert atmosphere. During this process, the plasma serves to remove carbonate-containing species from the surface and the heat treatment liberates implanted gas from the surface that results from the plasma treatment.

In one embodiment, the lithium-stuffed garnet film or bilayer is contacted with plasma and heated in two consecutive steps. In certain embodiments, the lithium-stuffed garnet film or bilayer is contacted with plasma for less than about 9 minutes, less than about 7 minutes, less than about 5 minutes, less than about 3 minutes, less than about 2 minutes, or less than about 1 minute and then heated for less than about 9 minutes, less than about 7 minutes, less than about 5 minutes, less than about 3 minutes, less than about 2 minutes, or less than about 1 minute. In one embodiment, the lithium-stuffed garnet film or bilayer is contacted with plasma for less than about 10 minutes and then heated for less than about 9 minutes, less than about 7 minutes, less than about 5 minutes, less than about 3 minutes, less than about 2 minutes, or less than about 1 minute. In certain embodiments, the lithium-stuffed garnet film is contacted with plasma for less than about 9 minutes, less than about 7 minutes, less than about 5 minutes, less than about 3 minutes, less than about 2 minutes, or less than about 1 minute and then heated for less than about 10 minutes. In one embodiment, the lithium-stuffed garnet film or bilayer is contacted with plasma for less than about 5 minutes and then heated for less than about 5 minutes. In one embodiment, the lithium-stuffed garnet film or bilayer is contacted with plasma for less than about 2 minutes and then heated for less than about 2 minutes. In one embodiment, the lithium-stuffed garnet film or bilayer is contacted with plasma for about 2 minutes and then heated for about 1 minute.

In one embodiment, the steps of contacting the lithium-stuffed garnet film or bilayer with plasma and heating is conducted concurrently for less than about 10 minutes with additional heating after the concurrent exposure to plasma and heating has ended. In one embodiment, the additional heating is conducted for less than about 3 minutes, less than about 2 minutes, or less than about 1 minute. In one embodiment, the additional heating is conducted for about 1 minute. In one embodiment, the lithium-stuffed garnet film is contacted with plasma and heated concurrently for less than about 5 minutes with additional heating after the concurrent exposure to plasma and heating has stopped that lasts for less than about 3 minutes. In one embodiment, the lithium-stuffed garnet film or bilayer is contacted with plasma and heated concurrently for about 2 minutes with additional heating after the concurrent exposure to plasma and heating has stopped that lasts for about 1 minute.

In one embodiment, the lithium-stuffed garnet film or bilayer is heated at a temperature between about 500° C. to 800° C. In certain embodiments, the lithium-stuffed garnet film or bilayer is heated that is at least about 500° C., at least about 600° C. at least about 700° C. at least about 750° C., or at least about 800° C. In one embodiment, the lithium-stuffed garnet film or bilayer is heated at a temperature of about 600° C.

In one embodiment, the lithium-stuffed garnet film or bilayer is contacted with plasma for less than about 5 minutes and then heated at a temperature between about 500° C. to 800° C. for less than about 5 minutes. In one embodiment, the lithium-stuffed garnet film or bilayer is contacted with plasma for less than about 5 minutes and then heated at a temperature of about 600° C. for less than about 5 minutes.

In one embodiment, the lithium-stuffed garnet film or bilayer is contacted with plasma for less than about 2 minutes and then heated at a temperature between about 500° C. to 800° C. for less than about 2 minutes. In one embodiment, the lithium-stuffed garnet film or bilayer is contacted with plasma for less than about 2 minutes and then heated at a temperature of about 600° C. for less than about 2 minutes.

In one embodiment, the lithium-stuffed garnet film or bilayer is contacted with plasma for less than about 2 minutes and then heated at a temperature between about 500° C. to 800° C. for less than about 2 minutes. In one embodiment, the lithium-stuffed garnet film or bilayer is contacted with plasma for about 2 minutes and then heated at a temperature of about 600° C. for about 1 minute.

In one embodiment, the lithium-stuffed garnet film or bilayer is contacted with plasma and heated at a temperature between about 500° C. to 800° C. concurrently for less than about 5 minutes with additional heating at a temperature between about 500° C. to 800° C. after the concurrent exposure to plasma and heating has stopped that lasts for less than about 3 minutes.

In one embodiment, the lithium-stuffed garnet film or bilayer is contacted with plasma and heated at a temperature between about 500° C. to 800° C. concurrently for about 2 minutes with additional heating at a temperature between about 500° C. to 800° C. after the concurrent exposure to plasma and heating has stopped that lasts for about 1 minute.

In one embodiment, the lithium-stuffed garnet film or bilayer is contacted with plasma and heated at a temperature of about 600° C. concurrently for less than about 5 minutes with additional heating at a temperature of about 600° C. after the concurrent exposure to plasma and heating has stopped that lasts for less than about 3 minutes.

In one embodiment, the lithium-stuffed garnet film or bilayer is contacted with plasma and heated at a temperature of about 600° C. concurrently for about 2 minutes with additional heating at a temperature between about 600° C. after the concurrent exposure to plasma and heating has stopped that lasts for about 1 minute.

In one embodiment, the lithium-stuffed garnet film is contacted with plasma and heated in the presence of an inert atmosphere selected from argon, nitrogen, hydrogen, or a mixture thereof. In one embodiment, the inert atmosphere is argon. In one embodiment, the inert atmosphere is nitrogen. In one embodiment, the film is contacted with plasma in the presence of argon and heated in the presence of nitrogen.

In one embodiment, the lithium-stuffed garnet film or bilayer is contacted with plasma for less than about 2 minutes in the presence of an argon atmosphere and then heated at a temperature between about 500° C. to 800° C. for less than about 2 minutes in the presence of a nitrogen atmosphere. In one embodiment, the lithium-stuffed garnet film is contacted with plasma in the presence of an argon atmosphere for about 2 minutes and then heated at a temperature of about 600° C. for about 1 minute in the presence of a nitrogen atmosphere.

In one embodiment, the lithium-stuffed garnet film or bilayer is contacted with plasma and heated at a temperature between about 500° C. to 800° C. concurrently in the presence of an argon atmosphere for about 2 minutes with additional heating at a temperature between about 500° C. to 900° C. after the concurrent exposure to plasma and heating has stopped that lasts for about 1 minute.

In one embodiment, the lithium-stuffed garnet film or bilayer is contacted with plasma and heated at a temperature of about 600° C. concurrently in the presence of an argon atmosphere for about 2 minutes with additional heating at a temperature of about 600° C. after the concurrent exposure to plasma and heating has stopped that lasts for about 1 minute.

The lithium-stuffed garnet films or bilayer can be subjected to the plasma treatment in a configurable plasma etch system, for example the BT-1 developed by Plasma Etch, the HPT-500 developed by Princeton Scientific Corporation, or a NEBULA plasma surface treatment system developed by Henniker plasma. In one embodiment, the pressure in the vacuum chamber is reduced to a pressure that is between about 75 mTorr and 750 mTorr, for example about 200 mTorr. In one embodiment, the radio frequency introduced in the chamber is about 13.56 KHz.

The present disclosure also provides a film wherein the surface of the film is characterized as having less than about a 0.5 μm thick layer thereupon comprising lithium carbonate, lithium hydroxide, lithium oxide, lithium peroxide, a hydrate thereof, an oxide thereof, or a combination thereof as measured by XPS or FT-IR; and wherein the surface of the film comprises a gas as detected by XPS or FT-IR wherein the gas is selected from argon, oxygen, nitrogen, or a mixture thereof.

In certain embodiments, the surface of the film is characterized as having less than about a 0.25 μm thick layer thereupon comprising lithium carbonate, lithium hydroxide, lithium oxide, lithium peroxide, a hydrate thereof, an oxide thereof, or a combination thereof as measured by XPS or FT-IR; and wherein the surface of the film comprises a gas as detected by XPS or FT-IR wherein the gas is selected from argon, oxygen, nitrogen, or a mixture thereof. In one embodiment, the gas is argon.

In certain embodiments, the surface of the film is characterized as having less than about a 0.15 μm thick layer thereupon comprising lithium carbonate, lithium hydroxide, lithium oxide, lithium peroxide, a hydrate thereof, an oxide thereof, or a combination thereof as measured by XPS or FT-IR; and wherein the surface of the film comprises a gas as detected by XPS or FT-IR wherein the gas is selected from argon, oxygen, nitrogen, or a mixture thereof. In one embodiment, the gas is argon.

In certain embodiments, the surface of the film is characterized as having less than about a 0.1 μm thick layer thereupon comprising lithium carbonate, lithium hydroxide, lithium oxide, lithium peroxide, a hydrate thereof, an oxide thereof, or a combination thereof as measured by XPS or FT-IR; and wherein the surface of the film comprises a gas as detected by XPS or FT-IR wherein the gas is selected from argon, oxygen, nitrogen, or a mixture thereof. In one embodiment, the gas is argon.

In certain embodiments, the surface of the film is characterized as having less than about a 0.05 μm thick layer thereupon comprising lithium carbonate, lithium hydroxide, lithium oxide, lithium peroxide, a hydrate thereof, an oxide thereof, or a combination thereof as measured by XPS or FT-IR; and wherein the surface of the film comprises a gas as detected by XPS or FT-IR wherein the gas is selected from argon, oxygen, nitrogen, or a mixture thereof. In one embodiment, the gas is argon.

In certain embodiments, the surface of the film is characterized as having no detectable layer thereupon comprising lithium carbonate, lithium hydroxide, lithium oxide, lithium peroxide, a hydrate thereof, an oxide thereof, or a combination thereof as measured by XPS or FT-IR; and wherein the surface of the film comprises a gas as detected by XPS or FT-IR wherein the gas is selected from argon, oxygen, nitrogen, or a mixture thereof. In one embodiment, the gas is argon.

### Surface-Treatment of Lithium-Stuffed Garnet Using UV-Light

In one embodiment, the present disclosure provides a process for surface-treating a lithium-stuffed garnet film or bilayer by removing or minimizing lithium carbonate, lithium hydroxide, lithium oxide, lithium peroxide, a hydrate thereof, an oxide thereof, or a combination thereof from the surface of the film or bilayer wherein the process comprises irradiating the film or bilayer with UV-light in the presence of a reducing or inert atmosphere and a low oxygen atmosphere.

In one embodiment, the film or bilayer is radiated with UV-light for at least about 90 minutes, at least about 72 minutes, at least about 60 minutes, at least about 45 minutes, at least about 36 minutes, at least about 30 minutes, at least about 20 minutes, at least about 12 minutes, at least about 10 minutes, at least about 6 minutes, or at least about 3 minutes. In one embodiment, the film is radiated with UV-light for about 90 minutes, about 72 minutes, about 60 minutes, about 45 minutes, about 36 minutes, about 30 minutes, about 20 minutes, about 12 minutes, about 10 minutes, about 6 minutes, or about 3 minutes.

In one embodiment, the film or bilayer is radiated with UV-light for about 20 seconds to 20 minutes. In one embodiment, the film or bilayer is radiated with UV-light for about 20 seconds to 15 minutes. In one embodiment, the film or bilayer is radiated with UV-light for about 20 seconds to 15 minutes. In one embodiment, the film or bilayer is radiated with UV-light for about 20 seconds to 15 minutes. In one embodiment, the film or bilayer is radiated with UV-light for about 20 seconds to 8 minutes. In one embodiment, the film or bilayer is radiated with UV-light for about 20 seconds to 15 minutes. In one embodiment, the film or bilayer is radiated with UV-light for about 20 seconds to 5 minutes. In one embodiment, the film or bilayer is radiated with UV-light for about 20 seconds to 3 minutes. In one embodiment, the film or bilayer is radiated with UV-light for about 20 seconds to 1 minute.

In one embodiment, the film or bilayer is radiated with UV-light for about 1 minute to 3 minutes. In one embodiment, the film or bilayer is radiated with UV-light for about 3 minutes to 5 minutes. In one embodiment, the film or bilayer is radiated with UV-light for about 5 minutes to 8 minutes. In one embodiment, the film or bilayer is radiated with UV-light for about 8 minutes to 12 minutes. In one embodiment, the film or bilayer is radiated with UV-light for about 12 minutes to 15 minutes. In one embodiment, the film or bilayer is radiated with UV-light for about 15 minutes to 20 minutes.

In one embodiment, the film or bilayer is radiated with UV-light for less than about 20 minutes, less than about 15 minutes, less than about 12 minutes, less than about 10 minutes, less than about 8 minutes, less than about 7 minutes, less than about 6 minutes, less than about 5 minutes, less than about 4 minutes, less than about 3 minutes, less than about 2 minutes, less than about 1 minute, less than about 50 seconds, less than about 45 seconds, less than about 30 seconds, less than about 20 seconds, less than about 15 seconds, or less than about 10 seconds.

In one embodiment, the film or bilayer is radiated with UV-light for less than about 2 minutes, less than about 1 minute, less than about 45 seconds, or less than about 30 seconds.

In one embodiment, the film or bilayer is radiated with UV-light for about 2 minutes, about 1 minute, about 45 seconds, or about 30 seconds. In one embodiment, the film is radiated with UV-light for about 1 minute.

In one embodiment, the film or bilayer is radiated with UV-light for at least about 10 seconds, at least about 15 seconds, at least about 20 seconds, at least about 30 seconds, at least about 45 seconds, at least about 50 seconds, at least about 1 minute, at least about 2 minutes, at least about 3 minutes, at least about 4 minutes, at least about 6 minutes, at least about 7 minutes, at least about 8 minutes, at least about 10 minutes, at least about 12 minutes, at least about 15 minutes, or at least about 20 minutes.

In one embodiment, the film or bilayer is radiated with a F300S μwave powdered electrodeless lamp with a broad band UV-B light (200 nm-600 nm). In other embodiments, the film or bilayer is radiated with a F300S μwave powdered electrodeless lamp with one or two broad band UV-H lights (200 nm-600 nm)

In one embodiment, the film or bilayer is radiated with one UV-light. In one embodiment, the film or bilayer is radiated with one or more UV-lights. In one embodiment, the film or bilayer is radiated with two UV-lights.

In one embodiment, the UV-light wavelength is between 200 nm and 600 nm. In one embodiment, the UV-light wavelength is between 200 nm and 350 nm. In one embodiment, the UV-light wavelength is 250 nm.

In one embodiment, the power of the UV-light is between about 5 and 15 kW. In one embodiment, the power of the UV-light is between about 6 and 12 kW. In one embodiment, the power of the UV-light is between about 7 and 9 kW. In one embodiment, the power of the UV-light is about 7 kW. In one embodiment, the power of the UV-light is about 8 kW. In one embodiment, the power of the UV-light is about 9 kW.

In one embodiment, the film is radiated with two UV-lamp bulbs and the combined total power of the UV-lamp bulbs is between about 5 and 15 kW. In one embodiment, the combined total power of the UV-lamp bulbs is between about 6 and 12 kW. In one embodiment, the combined total power of the UV-lamp bulbs is between about 6 and 9 kW. In one embodiment, the combined total power of the UV-lamp bulbs is about 6 kW. In one embodiment, the combined total power of the UV-lamp bulbs is about 7 kW. In one embodiment, the combined total power of the UV-lamp bulbs is about 8 kW. In one embodiment, the combined total power of the UV-lamp bulbs is about 9 kW.

In one embodiment, the UV-lamp bulb height relative to the film or bilayer is between about 1.5 inches and 5.5 inches. In one embodiment, the UV-lamp bulb height relative to the film or bilayer is between about 2.1 inches and 3.0 inches. In one embodiment, the UV-lamp bulb height relative to the film is about 2.1 inches. In one embodiment, the UV-lamp bulb height relative to the film or bilayer is 5.8 cm. In one embodiment, the UV-lamp bulb height relative to the film or bilayer is the focal point as specified by the manufacture.

In one embodiment, the one or more UV-lamp bulb height relative to the film or bilayer is between about 1.5 inches and 6.0 inches and the combined total power of the UV-lamp bulbs is between about 5 and 15 kW. In one embodiment, the one or more UV-lamp bulb height relative to the film or bilayer is between about 1.5 inches and 6.0 inches and the combined total power of the UV-lamp bulbs is between about 6 and 9 kW. In one embodiment, the UV-lamp bulb height relative to the film or bilayer is between about 2.1 inches and 3.0 inches and the combined total power of the UV-lamp bulbs is between about 5 and 15 kW. In one embodiment, the UV-lamp bulb height relative to the film or bilayer is between about 2.1 inches and 3.0 inches and the combined total power of the UV-lamp bulbs is between about 6 and 9 kW. In one embodiment, the UV-lamp bulb height relative to the film or bilayer is about 2.1 inches and the combined total power of the UV-lamp bulbs is between about 5 and 15 kW. In one embodiment, the UV-lamp bulb height relative to the film or bilayer is about 2.1 inches and the combined total power of the UV-lamp bulbs is between about 6 and 9 kW. In one embodiment, the UV-lamp bulb height relative to the film or bilayer is the focal point and the combined total power of the UV-lamp bulbs is between about 5 and 15 kW. In one embodiment, the UV-lamp bulb height relative to the film or bilayer is the focal point and the combined total power of the UV-lamp bulbs is between about 6 and 9 kW. In one embodiment, the UV-lamp bulb height relative to the film or bilayer is 5.8 cm and the combined total power of the UV-lamp bulbs is between about 5 and 15 kW. In one embodiment, the UV-lamp bulb height relative to the film or bilayer is 5.8 cm and the combined total power of the UV-lamp bulbs is between about 6 and 9 kW.

In one embodiment, the one or more UV-lamp bulb height relative to the film or bilayer is between about 1.5 inches and 6.0 inches; the combined total power of the UV-lamp bulbs is between about 5 and 15 kW; and the film is radiated with UV-light for less than about 2 minutes, less than about 1 minute, less than about 45 seconds, or less than about 30 seconds. In one embodiment, the one or more UV-lamp bulb height relative to the film or bilayer is between about 1.5 inches and 6.0 inches; the combined total power of the UV-lamp bulbs is between about 6 and 9 kW; and the film is radiated with UV-light for less than about 2 minutes, less than about 1 minute, less than about 45 seconds, or less than about 30 seconds. In one embodiment, the UV-lamp bulb height relative to the film or bilayer is between about 2.1 inches and 3.0 inches; the combined total power of the UV-lamp bulbs is between about 5 and 15 kW; and the film or bilayer is radiated with UV-light for less than about 2 minutes, less than about 1 minute, less than about 45 seconds, or less than about 30 seconds. In one embodiment, the UV-lamp bulb height relative to the film or bilayer is between about 2.1 inches and 3.0 inches; the combined total power of the UV-lamp bulbs is between about 6 and 9 kW; and the film or bilayer is radiated with UV-light for less than about 2 minutes, less than about 1 minute, less than about 45 seconds, or less than about 30 seconds. In one embodiment, the UV-lamp bulb height relative to the film or bilayer is about 2.1 inches; the combined total power of the UV-lamp bulbs is between about 5 and 15 kW; and the film is radiated with UV-light for less than about 2 minutes, less than about 1 minute, less than about 45 seconds, or less than about 30 seconds. In one embodiment, the UV-lamp bulb height relative to the film or bilayer is about 2.1 inches; the combined total power of the UV-lamp bulbs is between about 6 and 9 kW; and the film or bilayer is radiated with UV-light for less than about 2 minutes, less than about 1 minute, less than about 45 seconds, or less than about 30 seconds. In one embodiment, the UV-lamp bulb height relative to the film or bilayer is the focal point; the combined total power of the UV-lamp bulbs is between about 5 and 15 kW; and the film is radiated with UV-light for less than about 2 minutes, less than about 1 minute, less than about 45 seconds, or less than about 30 seconds. In one embodiment, the UV-lamp bulb height relative to the film or bilayer is the focal point; the combined total power of the UV-lamp bulbs is between about 6 and 9 kW; and the film or bilayer is radiated with UV-light for less than about 2 minutes, less than about 1 minute, less than about 45 seconds, or less than about 30 seconds. In one embodiment, the UV-lamp bulb height relative to the film or bilayer is 5.8 cm; the combined total power of the UV-lamp bulbs is between about 5 and 15 kW; and the film is radiated with UV-light for less than about 2 minutes, less than about 1 minute, less than about 45 seconds, or less than about 30 seconds. In one embodiment, the UV-lamp bulb height relative to the film or bilayer is 5.8 cm; the combined total power of the UV-lamp bulbs is between about 6 and 9 kW; and the film or bilayer is radiated with UV-light for less than about 2 minutes, less than about 1 minute, less than about 45 seconds, or less than about 30 seconds.

In one embodiment, the lithium-stuffed garnet film or bilayer is radiated with UV-light in the presence of an inert atmosphere selected from argon, nitrogen, hydrogen, or a mixture thereof. In one embodiment, the inert atmosphere is argon. In one embodiment, the inert atmosphere is nitrogen.

In one embodiment, the lithium-stuffed garnet film or bilayer is radiated with UV-light in the presence of an inert and low oxygen atmosphere wherein the oxygen level is less than about 5 ppm. In one embodiment, the lithium-stuffed garnet film or bilayer is radiated with UV-light in the presence of an inert nitrogen and low oxygen atmosphere wherein the oxygen level is less than about 5 ppm. In one embodiment, the lithium-stuffed garnet film or bilayer is radiated with UV-light in the presence of a continuous nitrogen purge to maintain an oxygen level below 5 ppm and the flow of the nitrogen purge is greater than about 5 L/min, but less than 100 L/min. In one embodiment, the lithium-stuffed garnet film or bilayer is radiated with UV-light in the presence of a continuous nitrogen purge to maintain an oxygen level below 5 ppm and the flow of the nitrogen purge is greater than about 5 L/min, but less than 100 L/min. In one embodiment, the lithium-stuffed garnet film or bilayer is radiated with UV-light in the presence of a continuous nitrogen purge to maintain an oxygen level below 5 ppm and the flow of the nitrogen purge is greater than about 15 L/min, but greater than 100 L/min. In one embodiment, the oxygen level is less than 4 ppm. In one embodiment, the oxygen level is less than 3 ppm. In one embodiment, the oxygen level is less than 2 ppm. In one embodiment, the oxygen level is less than 1 ppm.

In one embodiment, the flow of the continuous nitrogen is turbulent. In one embodiment, the flow of the continuous nitrogen is laminar. In one embodiment, the flow of the continuous nitrogen is stabilized.

In one embodiment, the film or bilayer is exposed to UV-light via a conveyor belt wherein the film or bilayer is placed on the conveyor belt that moves at a preset speed to match a predetermined UV exposure time. In certain embodiments, the film or bilayer is first placed on a ceramic reflective plate wrapped in nickel foil or aluminum foil. In certain embodiments, the film or bilayer are held in place on the ceramic plate with nickel- or aluminum-wrapped cubes to prevent the film from moving. A UV light is mounted on top of the conveyor system and the ceramic plate and foil assembly is passed through the UV-light via the conveyor belt. This process can be performed with any benchtop conveyor system and UV-powered lamp, for example a F300S μwave powered electrodeless lamp with LC6B benchtop conveyor.

In one embodiment, the conveyor speed is between about 0.6 μm/min to 2.2 μm/min. In one embodiment, the conveyor speed is about 0.6 μm/min. In one embodiment, the film or bilayer is passed through the conveyor system between about 5 times and 70 times. In one embodiment, the film is passed through the conveyor system at least 5 times, at least 10 times, at least 15 times, at least 20 times, at least 30 times, at least 40 times, at least 50 times, at least 60 times, or at least 70 times. In certain embodiments, the film or bilayer is passed through the conveyor system at least 6, 13, 20, 40, or 60 times. In certain embodiments, the film is passed through the conveyor system at least 2, 3, 4, or 5 times. In certain embodiments, the film or bilayer is passed through the conveyor system 2 times.

In one embodiment, the conveyor speed is between about 1 mm/second and 25 mm/second, between about 1 mm/second and 20 mm/second, between about 1 mm/second and 15 mm/second, between about 1 mm/second and 15 mm/second, between about 1 mm/second and 10 mm/second, between about 1 mm/second and 5 mm/second, or between about 1 mm/second and 2.5 mm/second. In one embodiment, the conveyor speed is about 2.5 mm/second.

In one embodiment, the conveyor speed is between about 1 mm/second and 25 mm/second, between about 1 mm/second and 20 mm/second, between about 1 mm/second and 15 mm/second, between about 1 mm/second and 10 mm/second, between about 1 mm/second and 5 mm/second, or between about 1 mm/second and 2.5 mm/second and the film or bilayer is passed through the conveyor belt more than once, for example, two times, three times, four times, five times, or more. In one embodiment, the conveyor speed is about 2.5 mm/second and the film or bilayer is passed through the conveyor belt more than once, for example, two times, three times, four times, five times, or more.

In one embodiment, the conveyor speed is less than about 12.5 mm/second and the film or bilayer is passed through the conveyor belt more than once, for example, two times, three times, four times, five times, or more. In one embodiment, the conveyor speed is about 2.5 mm/second and the film or bilayer is passed through the conveyor belt more than once, for example, two times, three times, four times, five times, or more.

In one embodiment, the conveyor speed is between about 1 mm/second and 25 mm/second, between about 1 mm/second and 20 mm/second, between about 1 mm/second and 15 mm/second, between about 1 mm/second and 10 mm/second, between about 1 mm/second and 5 mm/second, or between about 1 mm/second and 2.5 mm/second; the film or bilayer is passed through the conveyor belt more than once, for example, two times, three times, four times, five times, or more; and, the combined total power of the one of more UV-lights is between about 5 and 15 kW.

In one embodiment, the conveyor speed is between about 1 mm/second and 25 mm/second, between about 1 mm/second and 20 mm/second, between about 1 mm/second and 15 mm/second, between about 1 mm/second and 10 mm/second, between about 1 mm/second and 5 mm/second, or between about 1 mm/second and 2.5 mm/second; the film or bilayer is passed through the conveyor belt more than once, for example, two times, three times, four times, five times, or more; and, the combined total power of the one or more UV-light is between about 6 and 12 kW.

In one embodiment, the conveyor speed is between about 1 mm/second and 25 mm/second, between about 1 mm/second and 20 mm/second, between about 1 mm/second and 15 mm/second, between about 1 mm/second and 10 mm/second, between about 1 mm/second and 5 mm/second, or between about 1 mm/second and 2.5 mm/second; the film or bilayer is passed through the conveyor belt more than once, for example, two times, three times, four times, five times, or more; and, the combined total power of the one of more UV-lights is between about 6 and 9 kW.

In one embodiment, the conveyor speed is less than about 12.5 mm/second; the film or bilayer is passed through the conveyor belt more than once, for example, two times, three times, four times, five times, or more; and, the combined total power of the one or more UV-lights is between about 5 and 15 kW.

In one embodiment, the conveyor speed is less than about 12.5 mm/second; the film or bilayer is passed through the conveyor belt more than once, for example, two times, three times, four times, five times, or more; and, the combined total power of the one or more UV-lights is between about 6 and 12 kW.

In one embodiment, the conveyor speed is less than about 12.5 mm/second; the film or bilayer is passed through the conveyor belt more than once, for example, two times, three times, four times, five times, or more; and, the combined total power of the one or more UV-lights is between about 6 and 9 kW.

In one embodiment, the conveyor speed is less than about 12.5 mm/second; the film or bilayer is passed through the conveyor belt more than once, for example, two times, three times, four times, five times, or more; and, the combined total power of the one or more UV-lights is about 6 kW.

In one embodiment, the conveyor speed is less than about 12.5 mm/second; the film or bilayer is passed through the conveyor belt more than once, for example, two times, three times, four times, five times, or more; and, the combined total power of the one or more UV-lights is about 7 kW.

In one embodiment, the conveyor speed is less than about 12.5 mm/second; the film or bilayer is passed through the conveyor belt more than once, for example, two times, three times, four times, five times, or more; and, the combined total power of the one or more UV-lights is about 8 kW.

In one embodiment, the conveyor speed is less than about 12.5 mm/second; the film or bilayer is passed through the conveyor belt more than once, for example, two times, three times, four times, five times, or more; and, the combined total power of the one or more UV-lights is about 9 kW.

In one embodiment, the conveyor speed is about 2.5 mm/second; the film or bilayer is passed through the conveyor belt more than once, for example, two times, three times, four times, five times, or more; and, the combined total power of the one or more UV-lights is between about 5 and 15 kW.

In one embodiment, the conveyor speed is about 2.5 mm/second; the film is passed through the conveyor belt more than once, for example, two times, three times, four times, five times, or more; and the combined total power of the one or more UV-lights is between about 6 and 12 kW.

In one embodiment, the conveyor speed is about 2.5 mm/second; the film or bilayer is passed through the conveyor belt more than once, for example, two times, three times, four times, five times, or more; and, the combined total power of the one or more UV-lights is between about 6 and 9 kW.

In one embodiment, the conveyor speed is about 2.5 mm/second; the film or bilayer is passed through the conveyor belt more than once, for example, two times, three times, four times, five times, or more; and, the combined total power of the one or more UV-lights is about 6 kW.

In one embodiment, the conveyor speed is about 2.5 mm/second; the film or bilayer is passed through the conveyor belt more than once, for example, two times, three times, four times, five times, or more; and, the combined total power of the one or more UV-lights is about 7 kW.

In one embodiment, the conveyor speed is about 2.5 mm/second; the film or bilayer is passed through the conveyor belt more than once, for example, two times, three times, four times, five times, or more; and, the combined total power of the one or more UV-lights is about 8 kW.

In one embodiment, the conveyor speed is about 2.5 mm/second; the film or bilayer is passed through the conveyor belt more than once, for example, two times, three times, four times, five times, or more; and, the combined total power of the one or more UV-lights is about 9 kW.

In one embodiment, the conveyor speed is about 2.5 mm/second; the film or bilayer is passed through the conveyor belt more than once, for example, two times, three times, four times, five times, or more; the film is irradiated for less than 1 minute, the combined total power of the one or more UV-lights is about 6 kW; the wavelength of the UV irradiation is 250 nm; the height of the UV-lamp relative to the film is the focal point, and the film is radiated with UV-light in the presence of an inert nitrogen and low oxygen atmosphere wherein the oxygen level is less than about 5 ppm and the flow of nitrogen is greater than about 15 L/min, but less than 100 L/min.

In one embodiment, the conveyor speed is about 2.5 mm/second; the film or bilayer is passed through the conveyor belt more than once, for example, two times, three times, four times, five times, or more; the film is irradiated for less than 1 minute, the combined total power of the one or more UV-lights is about 6 kW; the wavelength of the UV irradiation is 250 nm; the height of the UV-lamp relative to the film is the focal point, and the film is radiated with UV-light in the presence of an inert nitrogen and low oxygen atmosphere wherein the oxygen level is less than about 5 ppm, but less than 100 L/min.

In one embodiment, the conveyor speed is about 2.5 mm/second; the film or bilayer is passed through the conveyor belt more than once, for example, two times, three times, four times, five times, or more; the film is irradiated for less than 1 minute, the combined total power of the one or more UV-lights is about 6 kW the wavelength of the UV irradiation is 250 nm; the height of the UV-lamp relative to the film is about 5.8 cm, and the film is radiated with UV-light in the presence of an inert nitrogen and low oxygen atmosphere wherein the oxygen level is less than about 5 ppm and the flow of nitrogen is greater than about 15 L/min, but less than 100 L/min.

In one embodiment, the conveyor speed is about 2.5 mm/second; the film or bilayer is passed through the conveyor belt more than once, for example, two times, three times, four times, five times, or more; the film is irradiated for less than 1 minute, the combined total power of the one or more UV-lights is about 6 kW the wavelength of the UV irradiation is 250 nm; the height of the UV-lamp relative to the film is about 5.8 cm, and the film is radiated with UV-light in the presence of an inert nitrogen and low oxygen atmosphere wherein the oxygen level is less than about 5 ppm, but less than 100 L/min.

In other embodiments, the stage of the conveyor belt is fixed and the film or bilayer is exposed to UV-light for at least about 3 minutes, at least about 5 minutes, at least about 8 minutes, at least about 10 minutes, or at least about 15 minutes. In certain embodiments, the stage of the conveyor belt is fixed and the film or bilayer is exposed to UV-light for about 3 minutes, about 4 minutes, about 5 minutes, about 6 minutes, about 8 minutes, about 10 minutes, or about 15 minutes.

In other embodiments, the UV-treatment is conducted in a reflective UV-chamber that is purged with an inert gas, for example, nitrogen, argon, hydrogen, or a mixture thereof. In one embodiment, the UV-treatment is conducted with a focused UV beam. In one embodiment, the inert gas is nitrogen. In one embodiment, the film is exposed to UV-light in the UV-reflective chamber in the presence of an inert gas for at least about 5 minutes, at least about 10 minutes, at least about 15 minutes, at least about 20 minutes, at least about 30 minutes, at least about 45 minutes, at least about 60 minutes, at least about 75 minutes, at least about 90 minutes, or more. In certain embodiments, the film is exposed to UV-light in the UV-reflective chamber in the presence of an inert gas for about 12 minutes, for about 24 minutes, for about 36 minutes, or for about 72 minutes. In one embodiment, the film is exposed to UV-light in the UV-reflective chamber in the presence of nitrogen for at least about 72 minutes.

In certain embodiments, more than one, more than five, more than ten, more than twenty, or more films or bilayers are stacked and processed as a batch in the reflective chamber.

In an alternative embodiment, the lithium-stuffed garnet film or bilayer is irradiated with infrared light in the presence of a reducing or inert atmosphere and a low oxygen atmosphere.

In certain embodiments, prior to exposure to UV light under the conditions described herein, the carbonate on the surface of the film or bilayer is greater than about 50 atom counts/zirconium and following the exposure to UV light, the carbonate on the surface of the film or bilayer is less than about 10 atom counts/zirconium after the surface treatment. In certain embodiments, the surface carbonate is greater than about 60 atom counts/zirconium prior to the surface treatment and less than about 10 atom counts/zirconium after the surface treatment. In certain embodiments, the surface carbonate is greater than about 70 atom counts/zirconium prior to the surface treatment and less than about 10 atom counts/zirconium after the surface treatment. In certain embodiments, the surface carbonate is greater than about 80 atom counts/zirconium prior to the surface treatment and less than about 10 atom counts/zirconium after the surface treatment. In certain embodiments, the surface carbonate is greater than about 90 atom counts/zirconium prior to the surface treatment and less than about 10 atom counts/zirconium after the surface treatment. In certain embodiments, the surface carbonate is greater than about 100 atom counts/zirconium prior to the surface treatment and less than about 10 atom counts/zirconium after the surface treatment.

In certain embodiments, the surface carbonate is greater than about 100 atom counts/zirconium prior to the surface treatment and less than about 20 atom counts/zirconium after the surface treatment. In certain embodiments, the surface carbonate is greater than about 100 atom counts/zirconium prior to the surface treatment and less than about 30 atom counts/zirconium after the surface treatment. In certain embodiments, the surface carbonate is greater than about 100 atom counts/zirconium prior to the surface treatment and less than about 40 atom counts/zirconium after the surface treatment. In certain embodiments, the surface carbonate is greater than about 100 atom counts/zirconium prior to the surface treatment and less than about 50 atom counts/zirconium after the surface treatment.

In certain embodiments, the surface carbonate is greater than about 90 atom counts/zirconium prior to the surface treatment and less than about 20 atom counts/zirconium after the surface treatment. In certain embodiments, the surface carbonate is greater than about 90 atom counts/zirconium prior to the surface treatment and less than about 30 atom counts/zirconium after the surface treatment. In certain embodiments, the surface carbonate is greater than about 90 atom counts/zirconium prior to the surface treatment and less than about 40 atom counts/zirconium after the surface treatment. In certain embodiments, the surface carbonate is greater than about 90 atom counts/zirconium prior to the surface treatment and less than about 50 atom counts/zirconium after the surface treatment.

In certain embodiments, the surface carbonate is greater than about 80 atom counts/zirconium prior to the surface treatment and less than about 20 atom counts/zirconium after the surface treatment. In certain embodiments, the surface carbonate is greater than about 80 atom counts/zirconium prior to the surface treatment and less than about 30 atom counts/zirconium after the surface treatment. In certain embodiments, the surface carbonate is greater than about 80 atom counts/zirconium prior to the surface treatment and less than about 40 atom counts/zirconium after the surface treatment. In certain embodiments, the surface carbonate is greater than about 80 atom counts/zirconium prior to the surface treatment and less than about 50 atom counts/zirconium after the surface treatment.

In certain embodiments, the surface carbonate is greater than about 70 atom counts/zirconium prior to the surface treatment and less than about 20 atom counts/zirconium after the surface treatment. In certain embodiments, the surface carbonate is greater than about 70 atom counts/zirconium prior to the surface treatment and less than about 30 atom counts/zirconium after the surface treatment. In certain embodiments, the surface carbonate is greater than 7 about 0 atom counts/zirconium prior to the surface treatment and less than about 40 atom counts/zirconium after the surface treatment. In certain embodiments, the surface carbonate is greater than about 70 atom counts/zirconium prior to the surface treatment and less than about 50 atom counts/zirconium after the surface treatment.

In certain embodiments, the surface carbonate is greater than about 50 atom counts/zirconium prior to the surface treatment and less than about 20 atom counts/zirconium after the surface treatment. In certain embodiments, the surface carbonate is greater than about 50 atom counts/zirconium prior to the surface treatment and less than about 30 atom counts/zirconium after the surface treatment. In certain embodiments, the surface carbonate is greater than about 50 atom counts/zirconium prior to the surface treatment and less than about 40 atom counts/zirconium after the surface treatment.

### Lithium-Stuffed Garnet Films

In certain embodiments, the lithium-stuffed garnet film is characterized by a formula selected from Li_{A}La_{B}M′_{C}M″_{D}Ta_{E}O_{F}, Li_{A}La_{B}M′_{C}M″_{D}Nb_{E}O_{F}, wherein 4<A<8.5, 1.5<B<4, 0≤C≤2, 0≤D≤2; 0≤E<2, 10<F<14, and M′ and M′ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<14 and Me″ is a metal selected from Nb, Ta, V, W, Mo, or Sb, or combinations thereof.

In certain embodiments, a lithium-stuffed garnet bilayer comprises a layer of lithium-stuffed garnet, characterized by a formula selected from Li_{A}La_{B}M′_{C}M″_{D}Ta_{E}O_{F}, Li_{A}La_{B}M′_{C}M″_{D}Nb_{E}O_{F}, wherein 4<A<8.5, 1.5<B<4, 0≤C≤2, 0≤D≤2; 0≤E<2, 10<F<14, and M′ and M′ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<14 and Me″ is a metal selected from Nb, Ta, V, W, Mo, or Sb, or combinations thereof, and a layer of metal foil, wherein the metal foil comprises a metal selected from nickel (Ni), copper (Cu), an alloy thereof, and a combination thereof.

In certain embodiments, the lithium-stuffed garnet film is characterized by a formula selected from Li_{A}La_{B}M′cM″_{D}Zr_{E}O_{F}, Li_{A}La_{B}M′_{C}M′_{D}Ta_{E}O_{F}, Li_{A}La_{B}M′_{C}M′_{D}Nb_{E}O_{F}, wherein 4<A<8.5, 1.5<B<4, 0≤C≤2, 0≤D≤2; 0≤E<2, 10<F<14, and M′ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<14 and Me″ is a metal selected from Nb, Ta, V, W, Mo, or Sb, or combinations thereof.

In certain embodiments, the lithium-stuffed garnet film is characterized by a formula selected from Li_{A}La_{B}M′_{c}M″_{D}Zr_{E}O_{F}, Li_{A}La_{B}M′_{C}M″_{D}Ta_{E}O_{F}, Li_{A}La_{B}M′_{C}M″_{D}Nb_{E}O_{F}, wherein 4<A<8.5, 1.5<B<4, 0≤C≤2, 0≤D≤2; 0≤E<2, 10<F<13, and M′ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, Ta, V, W, Mo, or Sb, or combinations thereof.

In certain embodiments, the lithium-stuffed garnet film is characterized by the formula Li_{A}La_{B}M′_{C}M″_{D}Nb_{E}O_{F}, wherein 4<A<8.5, 1.5<B<4, 0≤C≤2, 0≤D≤2; 0≤E<2, 10<F<14, and M′ and M″ are each, independently in each instance selected from Al, Mo, W, Nb, Sb, Ca, Ba, Sr, Ce, Hf, Rb, or Ta, or combinations thereof.

In certain embodiments, the lithium-stuffed garnet film is characterized by the formula Li_{A}La_{B}M′_{C}M″_{D}Nb_{E}O_{F}, wherein 4<A<8.5, 1.5<B<4, 0≤C≤2, 0≤D≤2; 0≤E<2, 10<F<13, and M′ and M″ are each, independently in each instance selected from Al, Mo, W, Nb, Sb, Ca, Ba, Sr, Ce, Hf, Rb, or Ta.

In certain embodiments, the lithium-stuffed garnet film is characterized by the formula LiₐLa_{b}ZrₑAl_{d}Me″ₑO_{f}, wherein 5<a<7.7; 2<b<4; 0<c≤2.5; 0≤d<2; 0≤e<2, 10<f<14 and Me″ is a metal selected from Nb, Ta, V, W, Mo, or Sb.

In certain embodiments, the lithium-stuffed garnet film is characterized by the formula LiₐLa_{b}ZrₑAl_{d}Me″ₑO_{f}, wherein 5<a<7.7; 2<b<4; 0<c≤2.5; 0≤d<2; 0≤e<2, 10<f<13 and Me″ is a metal selected from Nb, Ta, V, W, Mo, or Sb.

In certain embodiments, the lithium-stuffed garnet film is characterized by the formula LiₓLa₃Zr₂O₁₂·y½Al₂O₃; wherein 5.0<x<9 and 0.1<y<1.5. In some of these examples, the garnet is LiₓLa₃Zr₂O₁₂·0.35Al₂O₃. In other of these examples, the garnet is Li₇La₃Zr₂O₁₂·0.35Al₂O₃.

In some of the examples, the garnet does not include any Nb, Ta, W or Mo, which is used herein to mean that the concentration of those elements (e.g., Nb, Ta, W, or Mo) is 10 parts per million (ppm) or lower. In some examples, the concentration of those elements (e.g., Nb, Ta, W, or Mo) is 1 parts per million (ppm) or lower. In some examples, the concentration of those elements (e.g., Nb, Ta, W, or Mo) is 0.1 parts per million (ppm) or lower.

In some examples, the lithium-stuffed garnet set forth herein can be represented by the general formula LiₓA₃B₂O₁₂, wherein 5<x<7. In some of these examples, A is a large ion occupying an 8-fold coordinated lattice site. In some of these examples, A is La, Sr, Ba, Ca, or a combination thereof. In some examples, B is a smaller more highly charged ion occupying an octahedral site. In some of these examples, B is Zr, Hf, Nb, Ta, Sb, V, or a combination thereof. In certain of these examples, the film is doped with 0.3 to 1 molar amount of Al per LiₓA₃B₂O₁₂. In certain of these examples, the film is doped with 0.35 molar amount of Al per LiₓA₃B₂O₁₂.

In some examples, the lithium-stuffed garnet film is characterized by the chemical formula LiₓLa₃Zr₂O₁₂ y(Al₂O₃), wherein 3≤x≤8 and 0≤y≤1. In some examples, the lithium-stuffed garnet film has an x as 3, 3.5, 4, 4.5, 5, 5.5, 6, 6.5, 7, 7.5, or 8.

In certain embodiments, the lithium-stuffed garnet film is characterized by LiₓLa₃Zr₂O_{z}·yAl₂O₃, wherein x is from 5 to 7.5; z is from 11 to 12.25; and y is from 0 to 1.

In some examples, the lithium stuffed garnet is Li₇La₃Zr₂O₁₂ (LLZ) and is doped with alumina. In certain examples, the LLZ is doped by adding Al₂O₃ to the reactant precursor mix that is used to make the LLZ. In certain other examples, the LLZ is doped by the aluminum in an aluminum reaction vessel that contacts the LLZ.

In some examples, the alumina doped LLZ has a high conductivity, e.g., greater than 10⁻⁴ S/cm at room temperature.

In some examples, a higher conductivity is observed when some of the Zr is partially replaced by a higher valence species, e.g., Nb, Ta, Sb, or combinations thereof. In some examples, the conductivity reaches as high as 10⁻³ S/cm at room temperature.

In some examples, the film set forth herein is LiₓA₃B₂O₁₂ doped with 0.35 molar amount of Al per LiₓA₃B₂O₁₂. In certain of these examples, x is 5. In certain other examples, x is 5.5. In yet other examples, x is 6.0. In some other examples, x is 6.5. In still other examples, x is 7.0. In some other examples, x is 7.5.

In some examples, the garnet-based film is doped with 0.3, 0.35, 0.4, 0.45, 0.5, 0.55, 0.6, 0.65, 0.7, 0.75, 0.8, 0.85, 0.9, 0.95, or 1 molar amount of Al per LiₓA₃B₂O₁₂.

In some examples, the garnet-based film is doped with 0.35 molar amount of Al per LiₓA₃B₂O₁₂.

In the examples, herein, the subscripts and molar coefficients in the empirical formulas are based on the quantities of raw materials initially batched to make the described examples.

In some examples, the lithium-stuffed garnet comprises lithium stuffed garnet and Al₂O₃. In certain examples, the lithium stuffed garnet is doped with alumina. In some examples, the lithium-stuffed garnet is characterized by the empirical formula Li_{A}La_{B}M′_{c}M″_{D}Zr_{E}O_{F}, wherein 4<A<8.5, 1.5<B<4, 0≤C≤2, 0≤D≤2; 0≤E≤2, 10<F≤13, and M′ and M″ are, independently in each instance, either absent or are each independently selected from Al, Mo, W, Nb, Sb, Ca, Ba, Sr, Ce, Hf, Rb, or Ta; and wherein the molar ratio of Al₂O₃:Garnet is between 0.05 and 0.7. In some examples, the lithium-stuffed garnet is characterized by the empirical formula Li_{A}La_{B}M′_{c}M″_{D}Zr_{E}O_{F}, wherein 2<A<10, 2<B<6, 0≤C≤2, 0≤D≤2; 0≤E≤3, 8<F≤14, and M′ and M″ are, independently in each instance, either absent or are each independently selected from Al, Mo, W, Nb, Sb, Ca, Ba, Sr, Ce, Hf, Rb, or Ta; and wherein the molar ratio of Al₂O₃:Garnet is between 0.01 and 2.

In some examples, the lithium stuffed garnet is Li_{A}La_{B}Zr_{C}M′_{D}M″_{E}O₁₂ and 5<A<7.7, 2<B<4, 0<C<2.5, M′ comprises a metal dopant selected from a material including Al and 0<D<2, M″ comprises a metal dopant selected from a material including Nb, Ta, V, W, Mo, Sb, and wherein 0<e<2. In some examples, the lithium stuffed garnet is a lithium stuffed garnet set forth in PCT Applications WO 2015/054320 and WO 2015/076944, entitled GARNET MATERIALS FOR LI SECONDARY BATTERIES AND METHODS OF MAKING AND USING GARNET MATERIALS, filed Oct. 7, 2014, the entire contents of which are herein incorporated by reference in its entirety for all purposes.

In some of the examples above, A is 6. In some other examples, A is 6.5. In other examples, A is 7.0. In certain other examples, A is 7.5. In yet other examples, A is 8.0.

In some of the examples above, B is 2. In some other examples, B is 2.5. In other examples, B is 3.0. In certain other examples, B is 3.5. In yet other examples, B is 3.5. In yet other examples, B is 4.0.

In some of the examples above, C is 0.5. In other examples C is 0.6. In some other examples, C is 0.7. In some other examples C is 0.8. In certain other examples C is 0.9. In other examples C is 1.0. In yet other examples, C is 1.1. In certain examples, C is 1.2. In other examples C is 1.3. In some other examples, C is 1.4. In some other examples C is 1.5. In certain other examples C is 1.6. In other examples C is 1.7. In yet other examples, C is 1.8. In certain examples, C is 1.9. In yet other examples, C is 2.0. In other examples C is 2.1. In some other examples, C is 2.2. In some other examples C is 2.3. In certain other examples C is 2.4. In other examples C is 2.5. In yet other examples, C is 2.6. In certain examples, C is 2.7. In yet other examples, C is 2.8. In other examples C is 2.9. In some other examples, C is 3.0.

In some of the examples above, D is 0.5. In other examples D is 0.6. In some other examples, D is 0.7. In some other examples D is 0.8. In certain other examples D is 0.9. In other examples D is 1.0. In yet other examples, D is 1.1. In certain examples, D is 1.2. In other examples D is 1.3. In some other examples, D is 1.4. In some other examples D is 1.5. In certain other examples D is 1.6. In other examples D is 1.7. In yet other examples, D is 1.8. In certain examples, D is 1.9. In yet other examples, D is 2.0. In other examples D is 2.1. In some other examples, D is 2.2. In some other examples D is 2.3. In certain other examples D is 2.4. In other examples D is 2.5. In yet other examples, D is 2.6. In certain examples, D is 2.7. In yet other examples, D is 2.8. In other examples D is 2.9. In some other examples, D is 3.0.

In some of the examples above, E is 0.5. In other examples E is 0.6. In some other examples, E is 0.7. In some other examples E is 0.8. In certain other examples E is 0.9. In other examples E is 1.0. In yet other examples, E is 1.1. In certain examples, E is 1.2. In other examples E is 1.3. In some other examples, E is 1.4. In some other examples E is 1.5. In certain other examples E is 1.6. In other examples E is 1.7. In yet other examples, E is 1.8. In certain examples, E is 1.9. In yet other examples, E is 2.0. In other examples E is 2.1. In some other examples, E is 2.2. In some other examples E is 2.3. In certain other examples E is 2.4. In other examples E is 2.5. In yet other examples, E is 2.6. In certain examples, E is 2.7. In yet other examples, E is 2.8. In other examples E is 2.9. In some other examples, E is 3.0.

In some of the examples above, F is 11.1. In other examples F is 11.2. In some other examples, F is 11.3. In some other examples F is 11.4. In certain other examples F is 11.5. In other examples F is 11.6. In yet other examples, F is 11.7. In certain examples, F is 11.8. In other examples F is 11.9. In some other examples, F is 12. In some other examples F is 12.1. In certain other examples F is 12.2. In other examples F is 12.3. In yet other examples, F is 12.3. In certain examples, F is 12.4. In yet other examples, F is 12.5. In other examples F is 12.6. In some other examples, F is 12.7. In some other examples F is 12.8. In certain other examples E is 12.9. In other examples F is 13.

In some particular examples, provided herein is a film characterized by the empirical formula LiₓLa₃Zr₂O₁₂·y½Al₂O₃; wherein 5.0<x<9 and 0.1<y<1.5. In some examples, x is 5. In other examples, x is 5.5. In some examples, x is 6. In some examples, x is 6.5. In other examples, x is 7. In some examples, x is 7.5. In other examples x is 8. In some examples, y is 0.3. In some examples, y is 0.35. In other examples, y is 0.4. In some examples, y is 0.45. In some examples, y is 0.5. In other examples, y is 0.55. In some examples, y is 0.6. In other examples y is 0.7. In some examples, y is 0.75. In other examples, y is 0.8. In some examples, y is 0.85. In other examples y is 0.9. In some examples, y is 0.95. In other examples, y is 1.0.

In some examples, provided herein is a film characterized by the empirical formula Li_{7.0}La₃(Zrₜ₁+Nbₜ₂+Taₜ₃)O₁₂+0.35Al₂O₃. In this formula, t1+t2+t3=subscript 2 so that the molar ratio of La to the combined amount of (Zr+Nb+Ta) is 3:2.

In some examples, provided herein is a film is characterized by the empirical formula Li₇La₃Zr₂O₁₂·0.35Al₂O₃.

In some of the above examples, A is 5, 6, 7, or 8. In certain examples, wherein A is 7.

In some of the above examples, M′ is Nb and M″ is Ta.

In some of the above examples, E is 1, 1.5, or 2. In certain examples, E is 2.

In some of the above examples, C and D are 0.

In some examples, provided herein is a film wherein the molar ratio of Al₂O₃:Garnet is between 0.1 and 0.65. In some examples, the Li:Al ratio is between 7:0.2 to 7:1.3. In some examples, the Li:Al ratio is between 7:0.3 to 7:1.2. In some examples, the Li:Al ratio is between 7:0.3 to 7:1.1. In some examples, the Li:Al ratio is between 7:0.4 to 7:1.0. In some examples, the Li:Al ratio is between 7:0.5 to 7:0.9. In some examples, the Li:Al ratio is between 7:0.6 to 7:0.8. In some examples, the Li:Al ratio is about 7:0.7. In some examples, the Li:Al ratio is 7:0.7.

In some examples, provided herein is a film wherein the molar ratio of Al₂O₃:Garnet is between 0.15 and 0.55.

In some examples, provided herein is a film wherein the molar ratio of Al₂O₃:Garnet is between 0.25 and 0.45.

In some examples, provided herein is a film wherein the molar ratio of Al₂O₃:Garnet is 0.35.

In some examples, provided herein is a film wherein the molar ratio of Al to garnet is 0.35.

In some examples, provided herein is a film wherein the lithium-stuffed garnet is characterized by the empirical formula Li₇La₃Zr₂O₁₂ and is doped with aluminum.

In some examples, the lithium stuffed garnet is Li₇La₃Zr₂O₁₂ (LLZ) and is doped with alumina. In certain examples, the LLZ is doped by adding Al₂O₃ to the reactant precursor mix that is used to make the LLZ. In certain other examples, the LLZ is doped by the aluminum in an aluminum reaction vessel that contacts the LLZ. When the LLZ is doped with alumina, conductive holes are introduced which increases the conductivity of the lithium stuffed garnet. In some examples, this increased conductivity is referred to as increased ionic (e.g., Li⁺) conductivity.

In certain embodiments, the lithium-stuffed garnet film is a bilayer comprising a layer of lithium-stuffed garnet and a layer of metal foil. In certain embodiments, the metal foil comprises a metal selected from nickel (Ni), copper (Cu), an alloy thereof, and a combination thereof.

In certain embodiments, the thin lithium-stuffed garnet film has top and bottom surfaces and a thickness therebetween, wherein the top or bottom surface length or width is greater than the thickness by a factor of ten (10) or more, and the thickness is from about 10 nm to about 100 μm. In some examples, the lithium-stuffed garnet film has a top or bottom surface length or width from about 100 μm to 100 cm.

In some examples, the lithium-stuffed garnet film is characterized by the chemical formula Liₓ₁La₃Zr₂O₁₂ y(Al₂O₃), wherein 3≤x1≤8 and 0≤y≤1; wherein the top or bottom surface or both is/are characterized by the chemical formula Liₓ₂La₃Zr₂O₁₂ y(Al₂O₃), wherein 3≤x1≤8 and 0≤y≤1, wherein x2 is less than x1.

In some examples herein, the Li-metal interface area specific resistance between 0 and 15 Ωcm² at 60° C. In some examples, the Li-metal interface area specific resistance is less than 2 Ωcm² at 60° C. In other examples, the Li-metal interface area specific resistance is less than 2 Ωcm² at 25° C. In certain examples, the Li-metal interface area specific resistance is less than 20 Ωcm² at −25° C.

In some examples, the film has a thickness of about 100 nm to about 100 μm. In some examples, the thin films set forth herein are less than about 50 μm in thickness. In some other examples, the thin films set forth herein are less than about 45 μm in thickness. In certain examples, the thin films set forth herein are less than about 40 μm in thickness. In still other examples, the thin films set forth herein are less than about 35 μm in thickness. In some examples, the thin films set forth herein are less than about 30 μm in thickness. In some other examples, the thin films set forth herein are less than about 25 μm in thickness. In certain examples, the thin films set forth herein are less than about 20 μm in thickness. In still other examples, the thin films set forth herein are less than about 15 μm in thickness. In some examples, the thin films set forth herein are less than about 10 μm in thickness. In some other examples, the thin films set forth herein are less than about 5 μm in thickness. In certain examples, the thin films set forth herein are less than about 0.5 μm in thickness. In still other examples, the thin films set forth herein are less than about 0.1 μm in thickness.

In certain examples, the thickness is about 50 μm. In other examples, the thickness is about 40 μm. In some examples, the thickness is about 30 μm. In other examples, the thickness is about 20 μm. In certain examples, the thickness is about 10 μm. In other examples, the thickness is about 5 μm. In some examples, the thickness is about 1 μm. In yet other examples, the thickness is about 0.5 μm.

In some of these examples, the films are about 1 mm in length. In some other of these examples, the films are about 5 mm in length. In yet other examples, the films are about 10 mm in length. In still other examples, the films are about 15 mm in length. In certain examples, the films are about 25 mm in length. In other examples, the films are about 30 mm in length. In some examples, the films are about 35 mm in length. In some other examples, the films are about 40 mm in length. In still other examples, the films are about 45 mm in length. In certain examples, the films are about 50 mm in length. In other examples, the films are about 30 mm in length. In some examples, the films are about 55 mm in length. In some other examples, the films are about 60 mm in length. In yet other examples, the films are about 65 mm in length. In still other examples, the films are about 70 mm in length. In certain examples, the films are about 75 mm in length. In other examples, the films are about 80 mm in length. In some examples, the films are about 85 mm in length. In some other examples, the films are about 90 mm in length. In still other examples, the films are about 95 mm in length. In certain examples, the films are about 100 mm in length. In other examples, the films are about 30 mm in length.

In some examples, the films are 1 cm in length. In some other examples, the films are 2 cm in length. In other examples, the films are 3 cm in length. In yet other examples, the films are 4 cm in length. In some examples, the films are 5 cm in length. In other examples, the films are 6 cm in length. In yet other examples, the films are 7 cm in length. In some other examples, the films are 8 cm in length. In yet other examples, the films are 9 cm in length. In still other examples, the films are 10 cm in length. In some examples, the films are 11 cm in length. In some other examples, the films are 12 cm in length. In other examples, the films are 13 cm in length. In yet other examples, the films are 14 cm in length. In some examples, the films are 15 cm in length. In other examples, the films are 16 cm in length. In yet other examples, the films are 17 cm in length. In some other examples, the films are 18 cm in length. In yet other examples, the films are 19 cm in length. In still other examples, the films are 20 cm in length. In some examples, the films are 21 cm in length. In some other examples, the films are 22 cm in length. In other examples, the films are 23 cm in length. In yet other examples, the films are 24 cm in length. In some examples, the films are 25 cm in length. In other examples, the films are 26 cm in length. In yet other examples, the films are 27 cm in length. In some other examples, the films are 28 cm in length. In yet other examples, the films are 29 cm in length. In still other examples, the films are 30 cm in length. In some examples, the films are 31 cm in length. In some other examples, the films are 32 cm in length. In other examples, the films are 33 cm in length. In yet other examples, the films are 34 cm in length. In some examples, the films are 35 cm in length. In other examples, the films are 36 cm in length. In yet other examples, the films are 37 cm in length. In some other examples, the films are 38 cm in length. In yet other examples, the films are 39 cm in length. In still other examples, the films are 40 cm in length. In some examples, the films are 41 cm in length. In some other examples, the films are 42 cm in length. In other examples, the films are 43 cm in length. In yet other examples, the films are 44 cm in length. In some examples, the films are 45 cm in length. In other examples, the films are 46 cm in length. In yet other examples, the films are 47 cm in length. In some other examples, the films are 48 cm in length. In yet other examples, the films are 49 cm in length. In still other examples, the films are 50 cm in length. In some examples, the films are 51 cm in length. In some other examples, the films are 52 cm in length. In other examples, the films are 53 cm in length. In yet other examples, the films are 54 cm in length. In some examples, the films are 55 cm in length. In other examples, the films are 56 cm in length. In yet other examples, the films are 57 cm in length. In some other examples, the films are 58 cm in length. In yet other examples, the films are 59 cm in length. In still other examples, the films are 60 cm in length. In some examples, the films are 61 cm in length. In some other examples, the films are 62 cm in length. In other examples, the films are 63 cm in length. In yet other examples, the films are 64 cm in length. In some examples, the films are 65 cm in length. In other examples, the films are 66 cm in length. In yet other examples, the films are 67 cm in length. In some other examples, the films are 68 cm in length. In yet other examples, the films are 69 cm in length. In still other examples, the films are 70 cm in length. In some examples, the films are 71 cm in length. In some other examples, the films are 72 cm in length. In other examples, the films are 73 cm in length. In yet other examples, the films are 74 cm in length. In some examples, the films are 75 cm in length. In other examples, the films are 76 cm in length. In yet other examples, the films are 77 cm in length. In some other examples, the films are 78 cm in length. In yet other examples, the films are 79 cm in length. In still other examples, the films are 80 cm in length. In some examples, the films are 81 cm in length. In some other examples, the films are 82 cm in length. In other examples, the films are 83 cm in length. In yet other examples, the films are 84 cm in length. In some examples, the films are 85 cm in length. In other examples, the films are 86 cm in length. In yet other examples, the films are 87 cm in length. In some other examples, the films are 88 cm in length. In yet other examples, the films are 89 cm in length. In still other examples, the films are 90 cm in length. In some examples, the films are 91 cm in length. In some other examples, the films are 92 cm in length. In other examples, the films are 93 cm in length. In yet other examples, the films are 94 cm in length. In some examples, the films are 95 cm in length. In other examples, the films are 96 cm in length. In yet other examples, the films are 97 cm in length. In some other examples, the films are 98 cm in length. In yet other examples, the films are 99 cm in length. In still other examples, the films are 100 cm in length. In some examples, the films are 101 cm in length. In some other examples, the films are 102 cm in length. In other examples, the films are 103 cm in length. In yet other examples, the films are 104 cm in length. In some examples, the films are 105 cm in length. In other examples, the films are 106 cm in length. In yet other examples, the films are 107 cm in length. In some other examples, the films are 108 cm in length. In yet other examples, the films are 109 cm in length. In still other examples, the films are 110 cm in length. In some examples, the films are 111 cm in length. In some other examples, the films are 112 cm in length. In other examples, the films are 113 cm in length. In yet other examples, the films are 114 cm in length. In some examples, the films are 115 cm in length. In other examples, the films are 116 cm in length. In yet other examples, the films are 117 cm in length. In some other examples, the films are 118 cm in length. In yet other examples, the films are 119 cm in length. In still other examples, the films are 120 cm in length.

In some examples, the film is a circle that is between about 20 and 5 mm in diameter. In some examples, the circle is about 5 mm in diameter. In some examples, the circle is about 7 mm in diameter. In some examples, the circle is about 9 mm in diameter. In some examples, the circle is about 10 mm in diameter. In some examples, the circle is about 11 mm in diameter. In some examples, the circle is about 13 mm in diameter. In some examples, the circle is about 15 mm in diameter. In some examples, the circle is about 17 mm in diameter. In some examples, the circle is about 20 mm in diameter.

In some examples, the film is a square and the dimensions are about 50 mm×50 mm. In some examples, the film is a square and the dimensions are about 45 mm×45 mm. In some examples, the film is a square and the dimensions are about 40 mm×40 mm. In some examples, the film is square and the dimensions are about 35 mm×35 mm. In some examples, the film is a square and the dimensions are about 30 mm×30 mm. In some examples, the film is a square and the dimensions are about 25 mm×25 mm. In some examples, the film is a square and the dimensions are about 20 mm×20 mm. In some examples, the film is a square and the dimensions are about 15 mm×15 mm. In some examples, the film is a square and the dimensions are about 10 mm×10 mm.

In some examples, the film is a rectangle and the dimensions are about 85 mm×100 mm. In some examples, the film is a rectangle and the dimensions are about 70 mm×85 mm. In some examples, the film is a rectangle and the dimensions are about 55 mm×70 mm. In some examples, the film is a rectangle and the dimensions are about 40 mm×55 mm. In some examples, the film is a rectangle and the dimensions are about 25 mm×40 mm.

In some examples, the garnet-based films are prepared as a monolith useful for a lithium secondary battery cell. In some of these cells, the form factor for the garnet-based film is a film with a top surface area of about 10 cm². In certain cells, the form factor for the garnet-based film with a top surface area of about 100 cm².

In some examples, the films set forth herein have a Young's Modulus of about 130-150 GPa. In some other examples, the films set forth herein have a Vicker's hardness of about 5-7 GPa.

In some examples, the films set forth herein have a porosity less than 20%. In other examples, the films set forth herein have a porosity less than 10%. In yet other examples, the films set forth herein have a porosity less than 5%. In still other examples, the films set forth herein have a porosity less than 3%.

In some examples, the disclosure sets forth herein a free-standing thin film Garnet-type electrolyte prepared by the method set forth herein. Exemplary free-standing thin films are found, for example, in US Patent Application Publication No. 2015/0099190, published on Apr. 9, 2015, entitled GARNET MATERIALS FOR LI SECONDARY BATTERIES AND METHODS OF MAKING AND USING GARNET MATERIALS, and filed Oct. 7, 2014, the contents of which are incorporated by reference in their entirety.

In some examples, set forth herein is a thin and free standing sintered garnet film, wherein the film thickness is less than 50 μm and greater than 10 nm, and wherein the film is substantially flat; and wherein the garnet is optionally bonded to a current collector (CC) film comprising a metal or metal powder on at least one side of the film.

In some examples, the thin and free standing sintered garnet film has thickness is less than 20 μm or less than 10 μm. In some examples, the thin and free standing sintered garnet film has a surface roughness of less than 5 μm. In some examples, the thin and free standing sintered garnet film has a surface roughness of less than 4 μm. In some examples, the thin and free standing sintered garnet film has a surface roughness of less than 2 μm. In some examples, the thin and free standing sintered garnet film has a surface roughness of less than 1 am. In certain examples, the garnet has a median grain size of between 0.1 μm to 10 μm. In certain examples, the garnet has a median grain size of between 2.0 am to 5.0 μm.

### IV. Solid-State Battery

In certain embodiments, the removal of surface lithium-containing species from lithium-stuffed garnet films using a surface-treatment described herein, enables a fast charge of the resulting lithium battery, for example a 0-80% charge in under 15 minutes. Therefore, another aspect of the present invention is a solid-state lithium battery that comprises 1) cathode active material; 2) a surface-treated lithium-stuffed garnet film treated with a surface-treatment process described herein; and 3) an anode active material wherein the solid-state battery can be charged from about 0-80% in under about 15 minutes.

In one embodiment, the solid-state lithium battery comprises 1) cathode active material selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; and a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1; 2) a lithium-stuffed garnet film made by a surface-treatment process described herein; and, 3) an anode active material selected from lithium metal, lithium titanate (Li₂TiO₃, LTO), carbon/graphite (C), silicon (Si)/silicon oxide (SiOₓ), lithium (Li), zinc (Zn), aluminum (Al), magnesium (Mg), alloys thereof, and combinations thereof.

In one embodiment, the solid-state lithium battery comprises 1) cathode active material; 2) a surface-treated lithium-stuffed garnet film wherein the film was radiated with UV-light in the presence of an inert or reducing atmosphere to remove lithium carbonate, lithium hydroxide, lithium oxide, lithium peroxide, a hydrate thereof, an oxide thereof, or a combination thereof from the surface of the film; and 3) an anode active material wherein the solid-state battery can be charged from about 0-80% in under about 15 minutes.

In one embodiment, the solid-state lithium battery comprises 1) cathode active material; 2) a surface-treated lithium-stuffed garnet film wherein the film was heated to at least 450° C. in the proximity of graphite and in the presence of an inert or reducing atmosphere to remove lithium carbonate, lithium hydroxide, lithium oxide, lithium peroxide, a hydrate thereof, an oxide thereof, or a combination thereof from the surface of the film; and 3) an anode active material wherein the solid-state battery can be charged from about 0-80% in under about 15 minutes.

In one embodiment, the solid-state lithium battery comprises 1) cathode active material; 2) a surface-treated lithium-stuffed garnet film wherein the film was heated to about 750° C. for 1 hour in the proximity of graphite and in the presence of an inert or reducing atmosphere to remove lithium carbonate, lithium hydroxide, lithium oxide, lithium peroxide, a hydrate thereof, an oxide thereof, or a combination thereof from the surface of the film; and 3) an anode active material wherein the solid-state battery can be charged from about 0-80% in under about 15 minutes.

In one embodiment, the solid-state lithium battery comprises 1) cathode active material; 2) a surface-treated lithium-stuffed garnet film wherein the film was contacted with plasma and heated in the presence of an inert or reducing atmosphere to remove lithium carbonate, lithium hydroxide, lithium oxide, lithium peroxide, a hydrate thereof, an oxide thereof, or a combination thereof from the surface of the film; and 3) an anode active material wherein the solid-state battery can be charged from about 0-80% in under about 15 minutes.

In one embodiment, the solid-state lithium battery comprises 1) cathode active material; 2) a surface-treated lithium-stuffed garnet film wherein the film was radiated with UV-light in the presence of an inert or reducing atmosphere and wherein the surface of the film is characterized by having less than a 0.5 μm layer thereupon comprising lithium carbonate, lithium hydroxide, lithium oxide, lithium peroxide, a hydrate thereof, an oxide thereof, or a combination thereof; and 3) an anode active material wherein the solid-state battery can be charged from about 0-80% in under about 15 minutes.

In one embodiment, the solid-state lithium battery comprises 1) cathode active material; 2) a surface-treated lithium-stuffed garnet film wherein the film was heated to at least 450° C. in the proximity of graphite and in the presence of an inert or reducing atmosphere to and wherein the surface of the film is characterized by having less than a 0.5 μm layer thereupon comprising lithium carbonate, lithium hydroxide, lithium oxide, lithium peroxide, a hydrate thereof, an oxide thereof, or a combination thereof; and 3) an anode active material wherein the solid-state battery can be charged from about 0-80% in under about 15 minutes.

In one embodiment, the solid-state lithium battery comprises 1) cathode active material; 2) a surface-treated lithium-stuffed garnet film wherein the film was heated to about 750° C. for 1 hour in the proximity of graphite and in the presence of an inert or reducing atmosphere and wherein the surface of the film is characterized by having less than a 0.5 μm layer thereupon comprising lithium carbonate, lithium hydroxide, lithium oxide, lithium peroxide, a hydrate thereof, an oxide thereof, or a combination thereof; and 3) an anode active material wherein the solid-state battery can be charged from about 0-80% in under about 15 minutes.

In one embodiment, the solid-state lithium battery comprises 1) cathode active material; 2) a surface-treated lithium-stuffed garnet film wherein the film was contacted with plasma and heated in the presence of an inert or reducing atmosphere and wherein the surface of the film is characterized by having less than a 0.5 μm layer thereupon comprising lithium carbonate, lithium hydroxide, lithium oxide, lithium peroxide, a hydrate thereof, an oxide thereof, or a combination thereof; and 3) an anode active material wherein the solid-state battery can be charged from about 0-80% in under about 15 minutes.

### V. Cathode Active Material

The cathode active material is not particularly limited herein, and a publicly known, prior art cathode active material utilized in all-solid-state batteries can be used. In particular, if a metal oxide is used as the cathode active material, sintering of the secondary battery can be performed in an oxygen-containing atmosphere. Specific examples of such a cathode active material include the following: manganese oxide (MnO), iron oxides, copper oxides, nickel oxides, lithium-manganese complex oxides (e.g., LiₓMn₂O₄ or LiₓMnO₂), lithium-nickel complex oxides (e.g., LiₓNiO₂), lithium-cobalt complex oxides (e.g. LiₓCoO₂), lithium cobalt nickel oxides (LiNi_{1-y}Co_{y}O₂), lithium-manganese-cobalt complex oxides (e.g., LiMn_{y}Co_{1-y}O₂), spinel-phase lithium-manganese-nickel complex oxides (e.g., LiₓMm_{2-y} Ni_{y}O₄), lithium phosphates having an olivine structure (e.g., LiₓFePO₄, LiₓFe_{1-y}Mn_{y}PO₄, LiₓCoPO₄), lithium phosphates having a NASICON-type structure (e.g, Li₇V₂(PO₄)₃), iron (III) sulfate (Fe₂(SO₄)₃), and vanadium oxides (e.g. V₂O₅). One type thereof can be used alone, or two or more types thereof can be used in combination. Preferably, x and y in these chemical formulas lie within the ranges of 1<x<5, and 0<y<1. Among the above, LiCoO₂, LiₓV₂(PO₄)₃, LiNiPO₄, and LiFePO₄ are preferred.

In certain embodiments, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In certain embodiments, including any of the foregoing, the cathode active material is selected from lithium cobalt oxide (LCO), lithium nickel cobalt aluminum oxide (NCA), lithium nickel manganese cobalt oxide (NMC), lithium iron phosphate (LFP), and combinations thereof.

In certain embodiments, including any of the foregoing, the cathode active material is selected from LiMPO₄ (M=Fe, Ni, Co, Mn), LiₓTi_{y}O_{z}, wherein x is from 0 to 8, y is from 1 to 12, z is from 1 to 24, LiMn₂O₄, LiMn₂ₐNiₐO₄, wherein a is from 0 to 2, LiCoO₂, Li(NiCoMn)O₂, Li(NiCoAl)O₂, and a nickel cobalt aluminum oxide.

In certain embodiments, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In certain embodiments, including any of the foregoing, the cathode active material is LiNiₓMn_{y}Co_{z}O₂, x+y+z=1, 0≤x≤1, 0≤y≤1, and 0≤z≤1. In one embodiment, the cathode active material is LiNiₓMn_{y}Co_{z}O₂, x is 0.8, y is 0.1, and z is 0.1. In certain other examples, the coated cathode active material is LiNiₓMn_{y}Co_{z}O₂, x is 0.6, y is 0.2, and z is 0.2. In one embodiment, the coated cathode active material is LiNiₓMn_{y}Co_{z}O₂, x is 0.5, y is 0.3, and z is 0.2. In some other examples, the coated cathode active material is LiNiₓMn_{y}Co_{z}O₂, x is ⅓, y is ⅓, and z is ⅓. In certain embodiments, the coated cathode active material is selected from LiMn₂O₄, LiCoO₂, Li(NiCoMn)O₂, and Li(NiCoAl)O₂.

In one embodiment, including any of the foregoing, the cathode active material is LiNiₓMn_{y}Co_{z}O₂, x+y+z=1, 0≤x≤1, 0≤y≤1, and 0≤z≤1. In certain examples, the amount of lithium in the cathode active material will vary depending on the state-of-charge of the battery. For example, the amount of lithium may range from Li_{0.95-1.1}(NiₓMn_{y}Co_{z})O₂, wherein x, y, and z, are as defined above. In certain other examples, the amount of lithium may range from Li_{0.2-1.1}(NiₓMn_{y}Co_{z})O₂, wherein x, y, and z, are as defined above. Other ranges of lithium are contemplated herein.

In one embodiment, including any of the foregoing, the cathode active material is LiNiₓMn_{y}Co_{z}O₂, x+y+z=1, 0≤x≤1, 0≤y≤1, and 0≤z≤1.

In one embodiment, including any of the foregoing, the cathode active material is LiNiₓMn_{y}Co_{z}O₂, x is 0.8, y is 0.1, and z is 0.1.

In one embodiment, including any of the foregoing, the cathode active material is LiNiₓMn_{y}Co_{z}O₂, x is 0.6, y is 0.2, and z is 0.2.

In one embodiment, including any of the foregoing, the cathode active material is LiNiₓMn_{y}Co_{z}O₂, x is 0.5, y is 0.3, and z is 0.2.

In one embodiment, including any of the foregoing, the cathode active material is LiNiₓMn_{y}Co_{z}O₂, x is ⅓, y is ⅓, and z is ⅓.

In one embodiment, including any of the foregoing, the cathode active material is selected from LiMn₂O₄, LiCoO₂, Li(NiCoMn)O₂, and Li(NiCoAl)O₂.

### VI. Methods of Making Lithium-Stuffed Garnet Films

The present disclosure provides processes for surface-treating lithium-stuffed garnet films. In some examples, set forth herein is method of making the film, which includes providing garnet chemical precursors to the electrolyte; calcining the chemical precursors to form a calcined electrolyte; providing a slurry comprising the calcined electrolyte; casting a film from the slurry; sintering the film; and surface-treating the sintered film in an inert or reducing atmosphere as described herein.

In some examples, the methods further include milling or mixing the chemical precursors before the calcining step.

In some examples, the sintering step in the methods herein becomes the surface-treatment step by controlling or changing the reducing or inert atmosphere.

In some examples, the sintering step in the methods herein becomes the surface-treatment step by changing the temperature of the sintered film.

Non-limiting embodiments of the present description include:

Embodiment 1. A process comprising: irradiating a lithium-stuffed garnet film or bilayer with UV-light in the presence of an inert or reducing and low oxygen atmosphere.

Embodiment 2. A process for removing lithium carbonate, lithium hydroxide, lithium oxide, lithium peroxide, a hydrate thereof, an oxide thereof, or a combination thereof, from the surface of a lithium-stuffed garnet film or bilayer comprising: irradiating the lithium-stuffed garnet bilayer with UV-light in the presence of an inert or reducing and low oxygen atmosphere.

Embodiment 3. The process of embodiment 1 or 2, wherein the lithium-stuffed garnet film or bilayer is radiated with UV-light for less than about 90 minutes.

Embodiment 4. The process of embodiment 3, wherein the lithium-stuffed garnet film or bilayer is radiated with UV-light for less than about 60 minutes.

Embodiment 5. The process of embodiment 3, wherein the lithium-stuffed garnet film or bilayer is radiated with UV-light for less than about 30 minutes.

Embodiment 6. The process of embodiment 3, wherein the lithium-stuffed garnet film or bilayer is radiated with UV-light for less than about 10 minutes.

Embodiment 7. The process of embodiment 3, wherein the lithium-stuffed garnet film or bilayer is radiated with UV-light for less than about 5 minutes.

Embodiment 8. The process of embodiment 3, wherein the lithium-stuffed garnet film or bilayer is radiated with UV-light for less than about 2 minutes.

Embodiment 9. The process of embodiment 3, wherein the lithium-stuffed garnet film or bilayer is radiated with UV-light for less than about 1 minute.

Embodiment 10. The process of embodiment 1 or 2, wherein the lithium-stuffed garnet film or bilayer is radiated with UV-light wherein the lithium-stuffed garnet film or bilayer is placed on a conveyor belt that moves at a conveyor speed between about 1 mm/second and 15 mm/second under the UV-light.

Embodiment 11. The process of embodiment 10, wherein the conveyor speed is between about 1 mm/second and 12.5 mm/second, between about 1 mm/second and 8 mm/second, between about 1 mm/second and 5 mm/second, or between about 1 mm/second and 3 mm/second.

Embodiment 12. The process of embodiment 11, wherein the conveyor speed is about 2.5 mm/second.

Embodiment 13. The process of any one of embodiments 1-12, wherein the UV-light has a wavelength range between 200 nm and 600 nm.

Embodiment 14. The process of embodiment 13, wherein the UV-light has a wavelength of 250 nm.

Embodiment 15. The process of embodiment 13, wherein the lithium-stuffed garnet film or bilayer is contacted with UV-light in the wavelength range between 200 nm and 600 nm in the presence of nitrogen for about 3 minutes.

Embodiment 16. The process of embodiment 15, wherein the lithium-stuffed garnet film or bilayer is contacted with UV-light with a wavelength of 250 nm in the presence of nitrogen for about 3 minutes.

Embodiment 17. The process of any one of embodiments 1-16, wherein the lithium-stuffed garnet film or bilayer is radiated with one UV-light lamp.

Embodiment 18. The process of any one of embodiments 1-16, wherein the lithium-stuffed garnet film or bilayer is radiated with two UV-light lamps.

Embodiment 19. The process of embodiment 17 or 18, wherein the combined total power of the UV-light lamp(s) is between about 6 and 12 kW.

Embodiment 20. The process of embodiment 19, wherein the combined total power is about 6 kW.

Embodiment 21. The process of embodiment 19, wherein the combined total power is about 7 kW.

Embodiment 22. The process of embodiment 19, wherein the combined total power is about 8 kW.

Embodiment 23. The process of any one of embodiments 10-22, wherein the film or bilayer is passed through the conveyer belt at least two, three, four, or five times.

Embodiment 24. The process of embodiment 20, wherein the lithium-stuffed film or garnet bilayer is passed through the conveyer belt at least two times.

Embodiment 25. The process of any one of embodiments 1-24, wherein the UV-light lamp height relative to the bilayer is the focal point.

Embodiment 26. The process of any one of embodiments 1-24, wherein the UV-light lamp height relative to the bilayer is 5.8 cm.

Embodiment 27. The process of any one of embodiments 1-26, wherein the lithium-stuffed film or garnet bilayer is radiated with UV-light in the presence of an inert and low oxygen atmosphere wherein the oxygen level is less than about 5 ppm.

Embodiment 28. The process of embodiment 27, wherein the film or bilayer is radiated with UV-light in the presence of a continuous nitrogen purge to maintain an oxygen level below 5 ppm and the flow of the nitrogen purge is greater than about 5 L/min, but less than 100 L/min.

Embodiment 29. The process of embodiment 28, wherein the nitrogen purge is greater than about 15 L/min.

Embodiment 30. The process of embodiment 10, wherein the conveyor speed is about 2.5 mm/second; the lithium-stuffed garnet film or bilayer is passed through the conveyor belt at least two times; the combined total power of the UV-light lamp(s) is about 6 kW; the wavelength of the UV irradiation is 250 nm; the height of the UV-lamp relative to the film or bilayer is the focal point; and, the bilayer is radiated with UV-light in the presence of an inert nitrogen and low oxygen atmosphere wherein the oxygen level is less than about 5 ppm.

Embodiment 31. The process of embodiment 10, wherein the conveyor speed is about 2.5 mm/second; the lithium-stuffed garnet film or bilayer is passed through the conveyor belt at least two times; the combined total power of the UV-light lamp(s) is 6 kW; the wavelength of the UV irradiation is 250 nm; the height of the UV-lamp is the focal point; and, the lithium-stuffed film or garnet bilayer is radiated with UV-light in the presence of an inert nitrogen and low oxygen atmosphere wherein the oxygen level is less than about 5 ppm.

Embodiment 32. A process comprising: heating a lithium-stuffed garnet film or bilayer to at least 450° C. in proximity to a carbon source, for example, graphite and in the presence of an inert or reducing atmosphere.

Embodiment 33. A process for removing lithium carbonate, lithium hydroxide, lithium oxide, lithium peroxide, a hydrate thereof, an oxide thereof, or a combination thereof, from the surface of lithium-stuffed garnet film or bilayer comprising: heating the lithium-stuffed garnet film or bilayer to at least 450° C. in proximity to a carbon source, for example graphite and in the presence of an inert or reducing atmosphere.

Embodiment 34. A process comprising: (a) contacting a lithium-stuffed garnet film or bilayer with a plasma in the presence of an inert or reducing atmosphere for less than about 10 minutes; and (b) heating the film or bilayer for less than about 10 minutes.

Embodiment 35. A process for removing lithium carbonate, lithium hydroxide, lithium oxide, lithium peroxide, a hydrate thereof, an oxide thereof, or a combination thereof, from the surface of lithium-stuffed garnet film or bilayer, comprising: (a) contacting the lithium-stuffed garnet film or bilayer with a plasma in the presence of an inert or reducing atmosphere for less than about 10 minutes; and (b) heating the film or bilayer for less than about 10 minutes.

Embodiment 36. The process of embodiment 34 or 35, wherein the heating is for the minimal time necessary to evaporate argon, hydrogen, nitrogen, or a mixture thereof from the lithium-stuffed garnet film or bilayer.

Embodiment 37. The process of embodiment 34 or 35, wherein the heating is for the minimal time necessary to melt only the surface of the film or bilayer.

Embodiment 38. The process of embodiment 34 or 35, wherein the heating is for the minimal time necessary to sinter only the surface of the film or bilayer.

Embodiment 39. The process of embodiment 34 or 35, wherein the lithium-stuffed garnet film or bilayer is (a) contacted with plasma for less than about 5 minutes and (b) heated for less than about 5 minutes.

Embodiment 40. The process of embodiment 34 or 35, wherein the lithium-stuffed garnet film or bilayer is (a) contacted with plasma for less than about 2 minutes and (b) heated for less than about 2 minutes.

Embodiment 41. The process of embodiment 34 or 35, wherein the lithium-stuffed garnet film or bilayer is (a) contacted with plasma for about 2 minutes and (b) heated for about 1 minute.

Embodiment 42. The process of any one of embodiments 32-41, wherein the lithium-stuffed garnet film or bilayer is heated to a temperature between about 500° C. and 800° C.

Embodiment 43. The process of any one of embodiments 32-41, wherein the lithium-stuffed garnet film or bilayer is heated to a temperature between about 750° C. and 850° C.

Embodiment 44. The process of embodiment 43, wherein the lithium-stuffed garnet film or bilayer is heated to about 750° C.

Embodiment 45. The process of embodiment 43, wherein the lithium-stuffed garnet film or bilayer is heated to about 600° C.

Embodiment 46. The process of any one of embodiments 32-33 and 42-45, wherein the lithium-stuffed garnet film or bilayer is in heated in proximity to graphite and in the presence of an inert or reducing atmosphere for about 1 hour.

Embodiment 47. The process of embodiment 46, wherein the lithium-stuffed garnet film or bilayer is heated to about 700° C. in proximity to graphite and in the presence of argon for about 1 hour

Embodiment 48. The process of embodiment 45, wherein the film or bilayer is (a) contacted with plasma in the presence of argon for about 2 minutes; and (b) heated for about 1 minute at 600° C.

Embodiment 49. The process of any one of embodiments 1-14 and 17-48, wherein the atmosphere is an inert atmosphere.

Embodiment 50. The process of embodiment 49, wherein the inert atmosphere is selected from argon, nitrogen, hydrogen, or a mixture thereof.

Embodiment 51. The process of embodiment 50, wherein the atmosphere is argon.

Embodiment 52. The process of embodiment 50, wherein the atmosphere is nitrogen.

Embodiment 53. The process of any one of embodiments 1-52, further comprising providing a film or bilayer with a surface characterized by having less than a 0.5 μm thick layer thereupon comprising lithium carbonate, lithium hydroxide, lithium oxide, lithium peroxide, a hydrate thereof, an oxide thereof, or a combination thereof as measured by x-ray photoelectron spectroscopy.

Embodiment 54. The process of any one of embodiments 1-52, further comprising providing a film or bilayer with a surface characterized by having less than a 0.25 μm thick layer thereupon comprising lithium carbonate, lithium hydroxide, lithium oxide, lithium peroxide, a hydrate thereof, an oxide thereof, or a combination thereof as measured by x-ray photoelectron spectroscopy.

Embodiment 55. The process of any one of embodiments 1-52, further comprising providing a film or bilayer with a surface characterized by having no detectable lithium carbonate, lithium hydroxide, lithium oxide, lithium peroxide, a hydrate thereof, an oxide thereof, or a combination thereof as measured by x-ray photoelectron spectroscopy.

Embodiment 56. The process of any one of embodiments 1-55, wherein the process comprises removing lithium carbonate, lithium hydroxide, or a combination thereof from the surface of the lithium-containing oxide.

Embodiment 57. A process comprising at least one process selected from: (1) irradiating a lithium-stuffed garnet film or bilayer with UV-light in the presence of an inert or reducing and low oxygen atmosphere; (2) heating the lithium-stuffed garnet film or bilayer to at least 450° C. in proximity to graphite and in the presence of an inert or reducing atmosphere; and, (3) contacting a lithium-stuffed garnet film or bilayer with a plasma in the presence of an inert or reducing atmosphere for less than about 10 minutes; and, heating the film or bilayer for less than about 10 minutes.

Embodiment 58. A process for removing lithium carbonate, lithium hydroxide, lithium oxide, lithium peroxide, a hydrate thereof, an oxide thereof, or a combination thereof, from the surface of a lithium-stuffed garnet film or bilayer, comprising at least one process selected from: (1) irradiating the lithium-stuffed garnet film or bilayer with UV-light in the presence of an inert or reducing and low oxygen atmosphere; (2) heating a lithium-stuffed garnet film or bilayer to at least 450° C. in proximity to graphite and in the presence of an inert or reducing atmosphere; and, (3) contacting a lithium-stuffed garnet film or bilayer with a plasma in the presence of an inert or reducing atmosphere for less than about 10 minutes; and, heating the film or bilayer for less than about 10 minutes.

Embodiment 59. A film or bilayer comprising lithium-stuffed garnet, wherein the film or bilayer has at least one surface that comprises argon, hydrogen, nitrogen, or a mixture thereof, as detected by x-ray photo-electron spectroscopy (XPS) or Fourier-transformed-infrared-red spectroscopy (FT-IR).

Embodiment 60. A lithium-stuffed garnet film or bilayer,
wherein the surface of the film or bilayer has less than a 0.5 μm thick layer of lithium carbonate, lithium hydroxide, lithium oxide, lithium peroxide, a hydrate thereof, an oxide thereof, or a combination thereof; and
wherein the surface of the film or bilayer comprises argon, hydrogen, nitrogen, or a mixture thereof, as detected by x-ray photo-electron spectroscopy (XPS) or Fourier-transformed-infrared-red spectroscopy (FT-IR).

Embodiment 61. The lithium-stuffed garnet film or bilayer of claim 59 or 60, wherein the surface of the film or bilayer comprises argon.

Embodiment 63. The lithium-stuffed garnet film or bilayer of any one of claims 59-61, wherein the surface of the film or bilayer has less than a 0.25 μm thick layer of lithium carbonate, lithium hydroxide, lithium oxide, lithium peroxide, a hydrate thereof, an oxide thereof, or a combination thereof as measured by x-ray photoelectron spectroscopy.

Embodiment 63. The film or bilayer of any one of claims 59-61, wherein the surface of the film or bilayer has no detectable lithium oxide, lithium peroxide, a hydrate thereof, an oxide thereof, or a combination thereof as measured by x-ray photoelectron spectroscopy.

In some embodiments, including any of the foregoing, set forth herein is a process comprising: irradiating a bilayer with UV-light; wherein the bilayer comprises a lithium-stuffed garnet layer disposed on a second layer; wherein the second layer is selected from a metal layer or a co-sintered layer of lithium-stuffed garnet and a metal; and wherein the irradiating is in the presence of an inert atmosphere; a reducing atmosphere; or a low oxygen atmosphere.

In some embodiments, including any of the foregoing, set forth herein is a process comprising: irradiating a lithium-stuffed garnet film with UV-light; wherein the irradiating is in the presence of an inert atmosphere; a reducing atmosphere; or a low oxygen atmosphere.

In some embodiments, including any of the foregoing, the bilayer comprises a lithium-stuffed garnet layer disposed on a second layer selected from a metal layer.

In some embodiments, including any of the foregoing, the metal layer is a metal foil.

In some embodiments, including any of the foregoing, the metal layer is a layer of Nickel (Ni), Copper (Cu), Aluminum (Al), Iron (Fe), an alloy thereof, or a combination thereof.

In some embodiments, including any of the foregoing, the bilayer comprises a lithium-stuffed garnet layer disposed on a second layer selected from a co-sintered layer of lithium-stuffed garnet and a metal.

In some embodiments, including any of the foregoing, the metal in the second layer is selected from Ni, Cu, Al, Fe, or a combination thereof.

In some embodiments, including any of the foregoing, the bilayer is radiated with UV-light for less than about 10 minutes.

In some embodiments, including any of the foregoing, the bilayer is radiated with UV-light for less than about 5 minutes.

In some embodiments, including any of the foregoing, the bilayer is radiated with UV-light for less than about 2 minutes.

In some embodiments, including any of the foregoing, the bilayer is radiated with UV-light for less than about 1 minute.

In some embodiments, including any of the foregoing, the bilayer is radiated with UV-light for less than about 45 seconds.

In some embodiments, including any of the foregoing, the bilayer is radiated with UV-light while the bilayer is disposed on a conveyor belt and the conveyor belt moves at a conveyor speed between about 1 mm/second and 15 mm/second under the UV-light.

In some embodiments, including any of the foregoing, the conveyor speed is between about 1 mm/second and 12.5 mm/second, between about 1 mm/second and 8 mm/second, between about 1 mm/second and 5 mm/second, or between about 1 mm/second and 3 mm/second.

In some embodiments, including any of the foregoing, the conveyor speed is about 2.5 mm/second.

In some embodiments, including any of the foregoing, the UV-light has a wavelength range between 200 nm and 600 nm.

In some embodiments, including any of the foregoing, the UV-light has a wavelength range of 250 nm.

In some embodiments, including any of the foregoing, the bilayer is contacted with UV-light in the wavelength range between 200 nm and 600 nm in the presence of nitrogen for about 3 minutes.

In some embodiments, including any of the foregoing, the bilayer is radiated with one UV-light lamp.

In some embodiments, including any of the foregoing, the bilayer is radiated with two UV-light lamps.

In some embodiments, including any of the foregoing, the combined total power of the UV-light lamp(s) is between about 6 and 12 kW.

In some embodiments, including any of the foregoing, the bilayer is passed through the conveyer belt at least two times.

In some embodiments, including any of the foregoing, the UV-light lamp height relative to the bilayer is the focal point of the UV-light lamp.

In some embodiments, including any of the foregoing, the UV-light lamp height relative to the bilayer is about 5.8 cm.

In some embodiments, including any of the foregoing, the bilayer is radiated with UV-light in the presence of an inert and low oxygen atmosphere wherein the oxygen level is less than about 5 ppm.

In some embodiments, including any of the foregoing, the bilayer is radiated with UV-light in the presence of a continuous nitrogen purge to maintain an oxygen level below 5 ppm and the flow of the nitrogen purge is greater than about 5 L/min and less than 100 L/min.

In some embodiments, including any of the foregoing, the nitrogen purge is greater than about 15 L/min.

In some embodiments, including any of the foregoing, the conveyor speed is about 2.5 mm/second; the bilayer is passed through the conveyor belt at least two times; the bilayer is irradiated for less than 1 minute; the combined total power of the UV-light lamp(s) is 6 kW; the wavelength of the UV light is 250 nm; the height of the UV-lamp relative to the bilayer is 5.8 cm; and, the bilayer is radiated with UV-light in the presence of an inert nitrogen and low oxygen atmosphere wherein the oxygen level is less than about 5 ppm.

In some embodiments, including any of the foregoing, set forth herein is a process comprising: heating a bilayer to at least 450° C. in proximity to graphite; wherein the bilayer comprises a lithium-stuffed garnet layer disposed on a second layer; wherein the second layer is selected from a metal layer or a co-sintered layer of lithium-stuffed garnet and a metal; and wherein the heating is in the presence of an inert atmosphere; a reducing atmosphere; or a low oxygen atmosphere.

In some embodiments, including any of the foregoing, set forth herein is a process comprising: heating a lithium-stuffed garnet film to at least 450° C. in proximity to graphite; wherein the heating is in the presence of an inert atmosphere; a reducing atmosphere; or a low oxygen atmosphere.

In some embodiments, including any of the foregoing, the heating is in the presence of an inert atmosphere or a reducing atmosphere.

In some embodiments, including any of the foregoing, the bilayer comprises a lithium-stuffed garnet layer disposed on a second layer selected from a metal layer.

In some embodiments, including any of the foregoing, the metal layer is a metal foil.

In some embodiments, including any of the foregoing, the metal layer is a layer of Nickel (Ni), Copper (Cu), Aluminum (Al), Iron (Fe), an alloy thereof, or a combination thereof.

In some embodiments, including any of the foregoing, the bilayer comprises a lithium-stuffed garnet layer disposed on a second layer selected from a co-sintered layer of lithium-stuffed garnet and a metal.

In some embodiments, including any of the foregoing, the metal in the second layer is selected from Ni, Cu, Al, Fe, or a combination thereof.

In some embodiments, including any of the foregoing, set forth herein is a process comprising: (a) contacting a bilayer with a plasma for less than about 10 minutes; wherein the bilayer comprises a lithium-stuffed garnet layer disposed on a second layer; wherein the second layer is selected from a metal layer or a co-sintered layer of lithium-stuffed garnet and a metal; and wherein the contacting is in the presence of an inert atmosphere; a reducing atmosphere; or a low oxygen atmosphere; and (b) heating the bilayer for less than about 10 minutes.

In some embodiments, including any of the foregoing, set forth herein is a process comprising: (a) contacting a lithium-stuffed garnet film with a plasma for less than about 10 minutes; wherein the contacting is in the presence of an inert atmosphere; a reducing atmosphere; or a low oxygen atmosphere; and (b) heating the lithium-stuffed garnet film for less than about 10 minutes.

In some embodiments, including any of the foregoing, the heating is in the presence of an inert atmosphere or a reducing atmosphere.

In some embodiments, including any of the foregoing, the bilayer comprises a lithium-stuffed garnet layer disposed on a second layer selected from a metal layer.

In some embodiments, including any of the foregoing, the metal layer is a metal foil.

In some embodiments, including any of the foregoing, the metal layer is a layer of Nickel (Ni), Copper (Cu), Aluminum (Al), Iron (Fe), an alloy thereof, or a combination thereof.

In some embodiments, including any of the foregoing, the bilayer comprises a lithium-stuffed garnet layer disposed on a second layer selected from a co-sintered layer of lithium-stuffed garnet and a metal.

In some embodiments, including any of the foregoing, the metal in the second layer is selected from Ni, Cu, Al, Fe, or a combination thereof.

In some embodiments, including any of the foregoing, the surface of the lithium-stuffed garnet layer of bilayer is characterized by a carbonate layer that has greater than about 50 atom counts/zirconium prior to a surface treatment and wherein the carbonate layer has less than about 10 atom counts/zirconium after the surface treatment.

In some embodiments, including any of the foregoing, the surface of the lithium-stuffed garnet layer of bilayer is characterized by a carbonate layer that has greater than about 70 atom counts/zirconium prior to a surface treatment and wherein the carbonate layer has less than about 10 atom counts/zirconium after the surface treatment.

In some embodiments, including any of the foregoing, the surface of the lithium-stuffed garnet layer of bilayer is characterized by a carbonate layer that has greater than about 100 atom counts/zirconium prior to a surface treatment and wherein the carbonate layer has less than about 10 atom counts/zirconium after the surface treatment.

In some embodiments, including any of the foregoing, set forth herein is a layer stack arrangement comprising: a plurality of layer stacks arranged one above the other wherein each layered stack comprises (1) a graphite plate and (2) a bilayer or a lithium-stuffed garnet film; wherein there is a gap between the graphite plate and (2); and wherein the bilayer comprises a lithium-stuffed garnet layer disposed on a second layer; wherein the second layer is selected from a metal layer or a co-sintered layer of lithium-stuffed garnet and a metal.

In some embodiments, including any of the foregoing, set forth herein is a layer stack arrangement comprising: a plurality of layer stacks arranged one above the other wherein each layered stack comprises (1) a graphite plate and (2) lithium-stuffed garnet film; wherein there is a gap between the graphite plate and the lithium-stuffed garnet film.

In some embodiments, including any of the foregoing, the heating is in the presence of an inert atmosphere or a reducing atmosphere.

In some embodiments, including any of the foregoing, the bilayer comprises a lithium-stuffed garnet layer disposed on a second layer selected from a metal layer.

In some embodiments, including any of the foregoing, the metal layer is a metal foil.

In some embodiments, including any of the foregoing, the metal layer is a layer of Nickel (Ni), Copper (Cu), Aluminum (Al), Iron (Fe), an alloy thereof, or a combination thereof.

In some embodiments, including any of the foregoing, the bilayer comprises a lithium-stuffed garnet layer disposed on a second layer selected from a co-sintered layer of lithium-stuffed garnet and a metal.

In some embodiments, including any of the foregoing, the metal in the second layer is selected from Ni, Cu, Al, Fe, or a combination thereof.

In some embodiments, including any of the foregoing, the gap between graphite layers is between about 0.2 mm to 20 mm.

In some embodiments, including any of the foregoing, the surface of the film or bilayer is characterized by having more than a 0.5 μm thick layer thereupon comprising lithium carbonate, lithium hydroxide, lithium oxide, lithium peroxide, a hydrate thereof, an oxide thereof, or a combination thereof as measured by x-ray photoelectron spectroscopy.

In some embodiments, including any of the foregoing, the surface of the film or bilayer is characterized by having less than a 0.5 μm thick layer thereupon comprising lithium carbonate, lithium hydroxide, lithium oxide, lithium peroxide, a hydrate thereof, an oxide thereof, or a combination thereof as measured by x-ray photoelectron spectroscopy.

In some embodiments, including any of the foregoing, the surface of the film or bilayer is characterized by having less than a 0.25 μm thick layer thereupon comprising lithium carbonate, lithium hydroxide, lithium oxide, lithium peroxide, a hydrate thereof, an oxide thereof, or a combination thereof as measured by x-ray photoelectron spectroscopy.

In some embodiments, including any of the foregoing, at least about 10 mm of space is maintained between each lithium-stuffed garnet film or bilayer.

In some embodiments, including any of the foregoing, set forth herein is a process for removing lithium carbonate, lithium hydroxide, lithium oxide, lithium peroxide, a hydrate thereof, an oxide thereof, or a combination thereof, from the surface of the lithium-containing film or bilayer of the layer stack arrangement set forth herein, comprising heating the layer stack arrangement in the presence of an inert atmosphere; a reducing atmosphere; or a low oxygen atmosphere.

In some embodiments, including any of the foregoing, set forth herein is a solid-state lithium battery comprising a bilayer prepared by the process set forth herein.

In some embodiments, including any of the foregoing, the surface of the bilayer is characterized by having less than a 0.5 μm thick layer thereupon comprising lithium carbonate, lithium hydroxide, lithium oxide, lithium peroxide, a hydrate thereof, an oxide thereof, or a combination thereof as measured by x-ray photoelectron spectroscopy.

In some embodiments, including any of the foregoing, the surface of the bilayer is characterized by no detectable thick layer thereupon comprising lithium carbonate, lithium hydroxide, lithium oxide, lithium peroxide, a hydrate thereof, an oxide thereof, or a combination thereof as measured by x-ray photoelectron spectroscopy.

In some embodiments, including any of the foregoing, wherein the solid-state battery includes cathode active material and anode active material.

In some embodiments, including any of the foregoing, wherein the solid-state battery can be charged from about 0-80% state-of-charge (SOC) in under about 15 minutes.

bilayer comprises a lithium-stuffed garnet layer disposed on a second layer; wherein the second layer is selected from a metal layer or a co-sintered layer of lithium-stuffed garnet and a metal; and wherein the irradiating is in the presence of an inert atmosphere; a reducing atmosphere; or a low oxygen atmosphere.

In some embodiments, including any of the foregoing, the bilayer comprises a lithium-stuffed garnet layer disposed on a second layer selected from a metal layer. In some embodiments, the metal layer is a metal foil. In some embodiments, the metal layer is a layer of Nickel (Ni), Copper (Cu), Aluminum (Al), Iron (Fe), an alloy thereof, or a combination thereof.

In some embodiments, the bilayer comprises a lithium-stuffed garnet layer disposed on a second layer selected from a co-sintered layer of lithium-stuffed garnet and a metal. In some embodiments, the metal in the second layer is selected from Ni, Cu, Al, Fe, or a combination thereof.

### EXAMPLES

Reagents, chemicals, and materials disclosed herein were commercially purchased unless stated otherwise.

Lithium-stuffed garnet films were prepared by depositing a slurry of lithium-stuffed garnet material by the doctor-blade method and sintering the deposited slurry on aluminum-based setters at 1000 to 1300° C. to prepare thin-films of lithium-stuffed garnet that were about 50 microns in thickness. The slurry, deposition, and sintering conditions are further found in U.S. Pat. No. 9,966,630 (titled ANNEALED GARNET ELECTROLYTE SEPARATORS, the entire contents of which are herein incorporated by reference in its entirety for all purposes). Casting was performed on a TQC drawdown table. Calendering was performed on an Innovative Machines Corporation (IMC) calender.

In certain embodiments, a broad band UV-B light (200 nm-600 nm, 300 Watts/inch (1800 Watts total output); F300S μwave powdered electrodeless lamp) was mounted above a moving conveyor (LC6B benchtop conveyor with F300S lamp system installed) to expose the films to UV-light. In other embodiments, a UV-H light F300S p wave powdered electrodeless lamp (model P300 MT model) was mounted above a moving conveyor (LC6B benchtop conveyor with F300S lamp system installed) and installed in a large sample containment purge box to expose the films to UV-light.

XPS systems (ThermoFisher Scientific K-Alpha) under dry atmosphere (−50° C.) were used. XPS analysis was performed with Monochromated, Micro-focused Al-Ka as X-ray source at a pressure of 108 Torr. The diameter of the analyzed area was 400 mm. Milling was performed using a Retsch PM 400 Planetary Ball Mill. Mixing was performed using a Fisher Scientific vortex mixer, a Flaktek speed mixer, or a Primix filmix homogenizer.

Unless specified otherwise, lithium-stuffed garnet films were prepared as follows. A slurry of lithium-stuffed garnet precursor materials were deposited by the doctor-blade method on aluminum-based setters and sintered at 1000° C. to 1300° C. to prepare thin-films of lithium-stuffed garnet that were about 50 microns (μm) in thickness.

Unless specified otherwise, co-sintered films (CSC films) were prepared as follows. A slurry of lithium-stuffed garnet precursor materials were casted onto mylar. A second slurry comprising nickel particles and additional lithium-stuffed garnet precursor materials was deposited (either method of screen-printed or casting) on top of the slurry of lithium-stuffed garnet materials. The resulting CSC bilayer was sintered on aluminum-based setters at 1000° C. to 1300° C. to prepare CSC films that were about 50 microns in thickness.

Unless specified otherwise, bilayer (film on metal foil) were prepared as follows. A slurry of lithium-stuffed garnet precursor materials was cast onto a metal foil and dried to form a green tape. The green tape cast on metal foil (bilayer before sintering) was unrolled and cut to the appropriate dimensions for sintering. This was done using a laser cutter. It is contemplated that a blade blanking tool could also be used. Discrete green sheets were then stacked between setter components and placed on support furniture used with the sintering apparatus. In this case, setter components refer to a dense Al₂O₃ plate onto which the green sheet was placed with the green tape side up, followed by a ceramic or metal frame component, followed by a metal sheet onto which a LiAlO₂ coating has been applied, followed by another dense Al₂O₃ plate.

The prepared sinter stacks, comprising support furniture, setter components, and discrete green sheet, were placed inside the vacuum furnace. To remove organic material from the green layer, the furnace was heated at atmospheric pressure to about 800° C. and held there for 15 min. The gas flow was 5.0 LPM (liters per minute) and included mostly nitrogen gas. Following organic material removal, the furnace was cooled to room temperature. Upon reaching room temperature, a partial vacuum was created inside the furnace by pumping with a dry vacuum pump that has a pumping speed of around 15 μm³/hr, while flowing 5.0 LPM nitrogen, resulting in a pressure of 14 Torr. Maintaining this condition throughout, the furnace was heated for sintering to about 1150° C. at a ramp rate of 50° C./min and held there for 1 min. The furnace was then cooled to room temperature. Upon reaching room temperature, the pumping was stopped, the furnace was vented to atmospheric pressure with nitrogen and the sinter stacks were removed from the furnace and disassembled.

### Example 1: Graphite Annealing Process

Lithium-lanthanum-zirconium-oxide (LLZO)-based CSC films (75000 μm×85000 μm×40 μm) were cleaned of debris via a makeup brush and a spraying gun (CDA gun). The films were prepared and sintered. The first film was loaded atop the first graphite plate. To assemble the stack, many graphite and film stacks were loaded atop each other in a tube furnace or kiln as shown in FIG. 1. A 10 mm space was maintained between each film. The films were then annealed for 1 hour at 750° C. under argon with a 5° C. per minute ramp rate on heating and cooling.

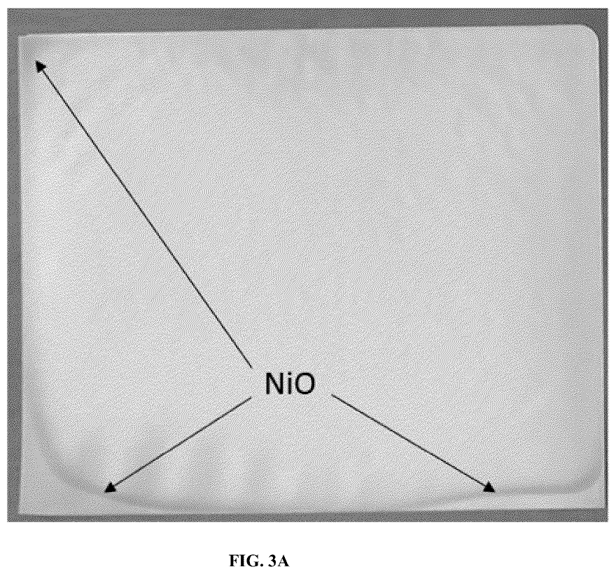

FIG. 2 is an XPS plot comparing the surface carbonate of a film that was sintered, but not annealed and a film that was sintered and graphite annealed, as in the preceding paragraph. As shown in FIG. 2, the carbonate peak is less intense for the film that was annealed with graphite compared to the film that was not.

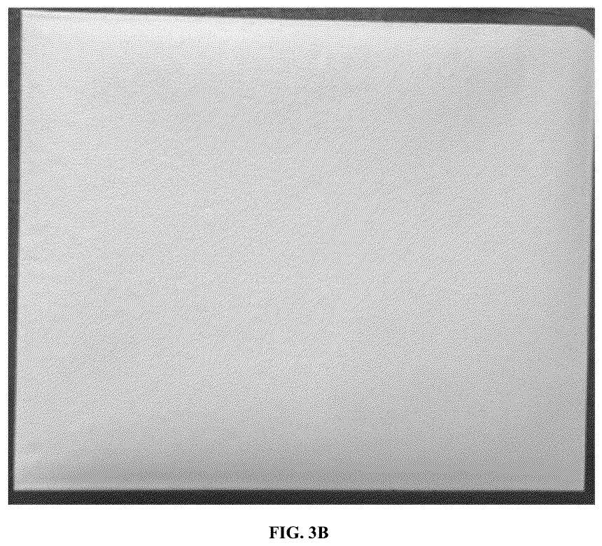

There was also evidence of NiO formation when the LLZO film was annealed without the reducing environment (not in the presence of graphite, but heat-treated at 750° C. for 1 hour under argon with an Al₂O₃ substrate). This is shown in FIG. 3A. In contrast and as shown in FIG. 3B, NiO was not observed when the film was annealed with a reducing environment (in the presence of graphite). Additionally, unlike the film annealed without the reducing environment, the global curvature of the film was maintained after annealing in the reducing environment.

### Example 2: Electrochemical Characterization of Oxide Annealed Using Graphite Process

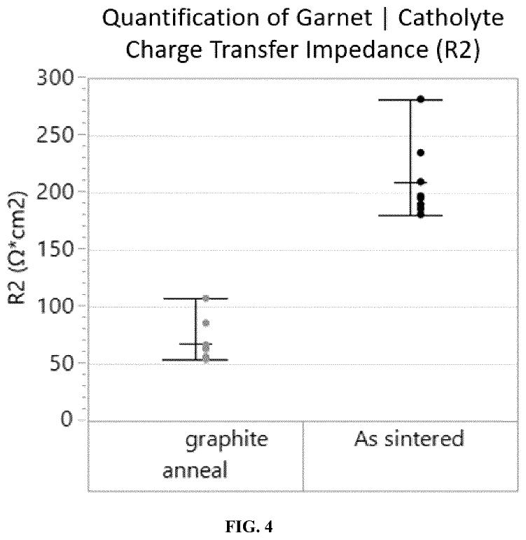

CSC Films were built into full cells. EIS was conducted on a VMP-3 system from Bio-Logic USA with a frequency range from 1 MHz to 100 mHz. FIG. 4 is a graph of the charge transfer impedance (R₂) for both electrochemical cells. As shown in FIG. 4, the charge transfer impedance (R₂) was much lower for the electrochemical cell with the annealed film compared to the electrochemical cell with the film that was only sintered.

### Example 3: State-of-Charge of Battery Containing Oxide Annealed Using Graphite Process

The CSC film from Example 2 was assembled into an energy storage system (ESS) battery with NMC cathode materials (NMC811 97 wt % active; 27% porosity). The resulting battery was charged and discharged at 45° C. within the operation voltage of 3 V to 4.4 V.

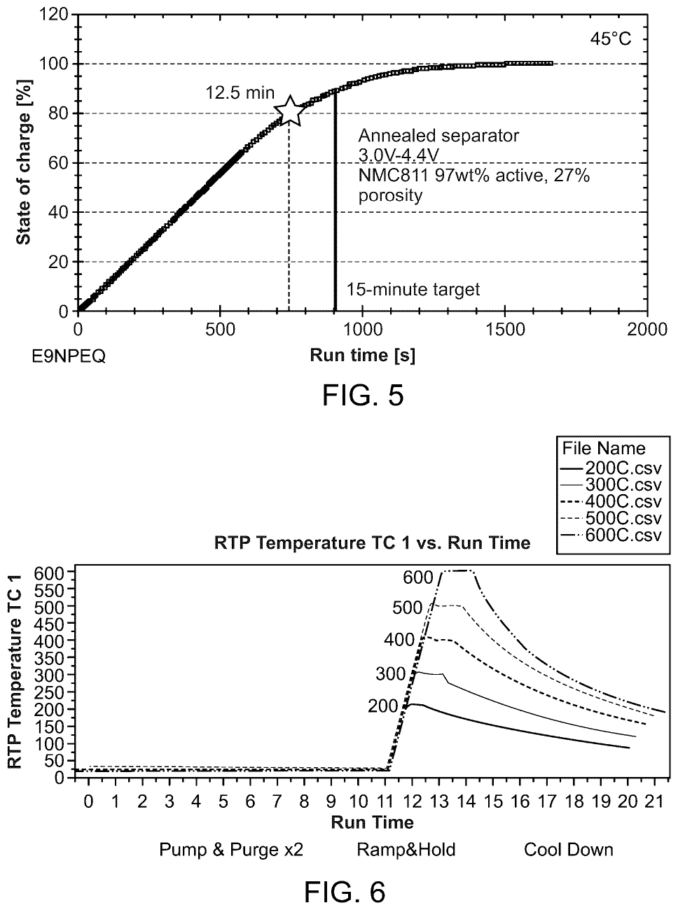

FIG. 5 is a graph plotting the state of charge measured in percent relative to the run time measured in seconds. As shown, the battery is charged from 0-80% in less than 15 minutes at 45° C. After annealing with graphite, the resulting surface layer is highly conductive, enabling a fast charge.

### Example 4: Plasma Annealing Process

LLZO-based CSC films prepared and sintered were plasma annealed using argon and then subjected to rapid temperature annealing to remove implanted argon. Plasma treatment was completed in a vacuum chamber with an RF power supply of 200 W for 2 minutes. Chamber pressure was 10 mTorr with argon as the process gas.

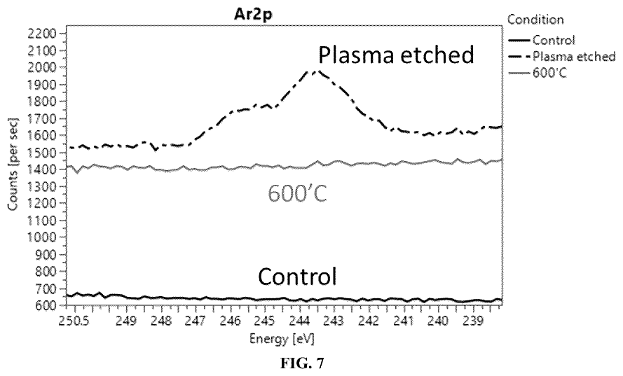

As shown in FIG. 6, the rapid temperature annealing (RTA) was conducted at 200° C., 300° C., 400° C., 500° C., and 600° C. At each temperature, following the pump and purge protocol, the temperature was ramped up (5° C./sec) and then held at the appropriate temperature for 10 seconds+60 seconds. This was followed by an appropriate cooling time. For the RTA, the process gas was N₂ and the flow rate was 2000 sscm (max).

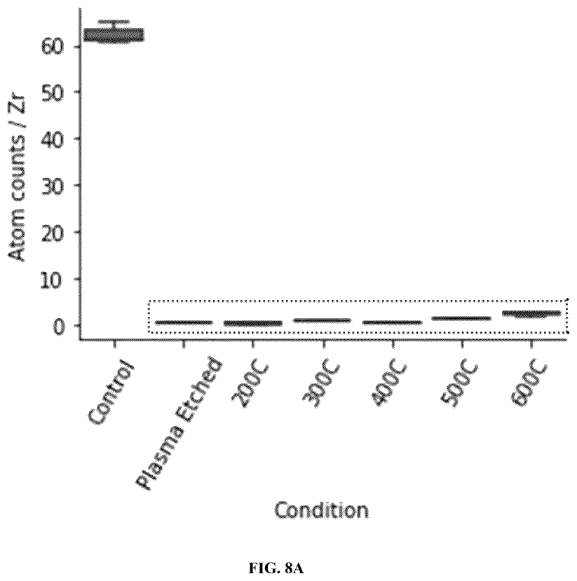

The removal of argon following the RTA was determined by XPS (measuring the peak intensity of the Ar2p peak) and the results are shown in FIG. 7. The control was a film with no plasma etching or RTA. As shown in FIG. 7, the argon peak was completely gone when the RTA was conducted at 600° C.

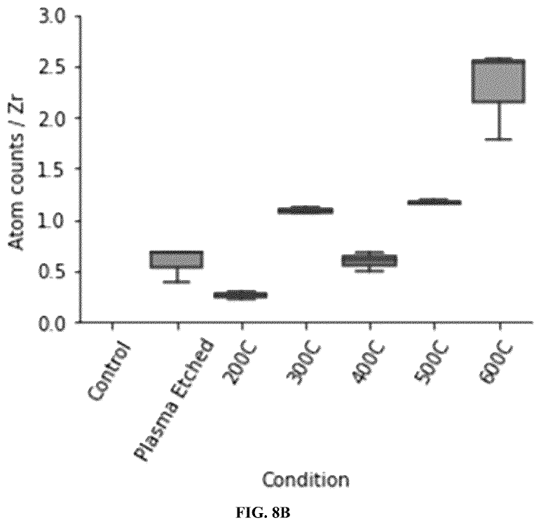

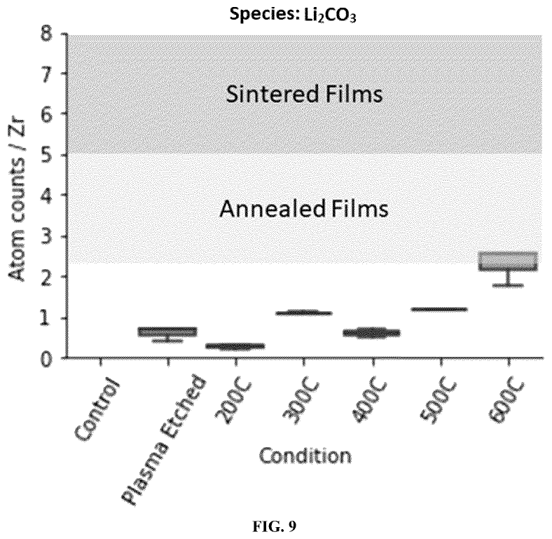

The carbonate removal following the RTA at various temperatures was also determined. As shown in FIG. 8A and FIG. 8B, plasma etching is effective at removing carbonate. Following rapid thermal annealing, the level of carbonate even at the highest temperature was still less than 3.0 atom counts/zirconium as measured by XPS (the carbonate level was taken from the O₂p peak, the zirconium is the 3d peak). This is compared to the control where the levels of carbonate were greater than 60 atom counts/zirconium. FIG. 8B is a magnification of the dotted box portion of FIG. 8A. This is also shown in FIG. 9 where the surface carbonate level is low (less than 3 atom counts/zirconium) in all treated films compared to the expected typical surface carbonate levels for separators that are sintered, but not annealed.

### Example 5: Electrochemical Characterization of Film Annealed Using Plasma Annealing Process

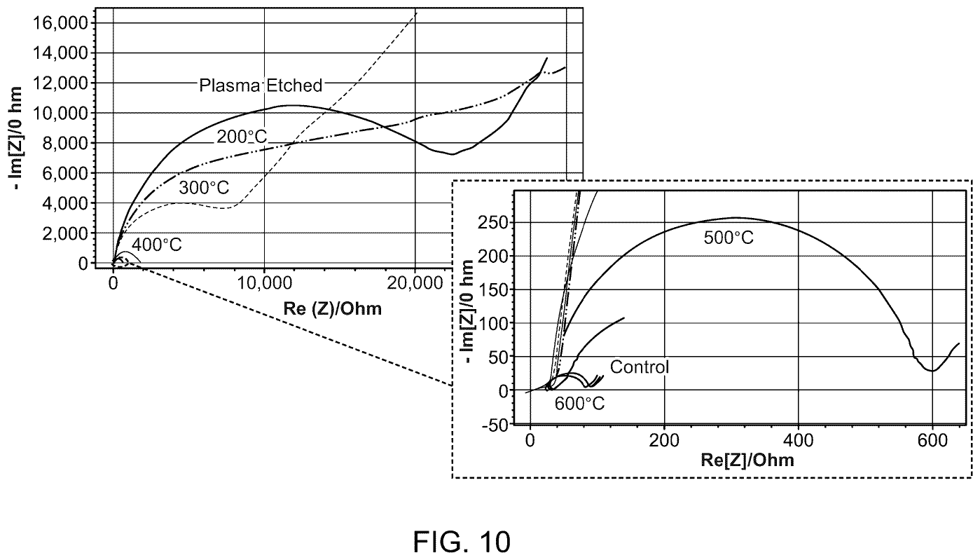

FIG. 10 is an EIS Nyquist plot of the electrochemical Swagelok cells containing the films that were subjected to plasma etching and thermal annealing at various temperatures. The impedance of the symmetric electrochemical cell containing the film that was plasma etched and thermally annealed at 600° C. was less than the impedance of the control, which was a sintered film that was exposed to air.

### Example 6: UV Annealing Process Via a Conveyor Belt

Abroad band UV-B light (200 nm-600 nm, 300 Watts/inch (1800 Watts total output); F300S μwave powdered electrodeless lamp) was mounted above a moving conveyor (LC6B benchtop conveyor with F300S lamp system installed). The exposure time/conveyor speed was 0.6 μm/minute-2.2 μm/minute and the bulb height was 2.1 inches-3.0 inches. The lamp illumination was controlled via the conveyor speed.

The experiments were run with moisture laden lithium-stuffed garnet films (films removed from the dry room) varying the conveyor speed (in some experiments, the stage was fixed), the residence time, the bulb height, the carrier material, and the ambient moisture. The UV-treatment was conducted in a dry room and only the garnet-side of the CSC film was exposed to UV-light. The control was a moisture laden lithium-stuffed garnet film that was passed through the conveyor, but not exposed to UV-light.

The films were mounted onto a reflective ceramic base and the reflective ceramic base was then placed on the conveyor. Nickel- or aluminum-wrapped cubes were placed on top of the film to prevent movement during the UV-treatment. The reflective base and film assembly was placed on nickel mounts to maintain a gap between the base and the conveyor belt. After UV-treatment, the samples were bagged and vacuum-sealed for XPS analysis. The XPS analysis determined the amount of surface carbonate. For certain tests, multiple films were tested.

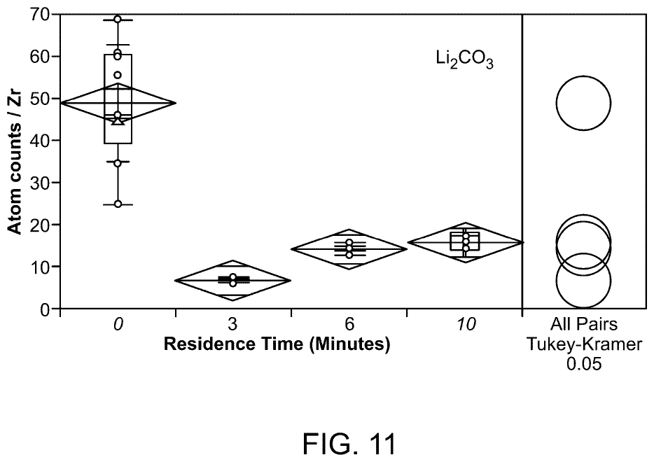

In one experiment, films were exposed to UV light for 3, 6, and 10 minutes on a fixed stage. The bulb height was 2.1 inches and the carrier material was a nickel foil-wrapped k plate. A one-way analysis comparing the surface carbonate measured by XPS of the control film and films after UV-treatment for 3, 6, and 10 minutes is shown in FIG. 11. XPS analysis of surface carbonate showed that a 3-minute exposure reduced the surface carbonate level from 49 atom counts/Zr to 6.6 atom counts/Zr. Exposure times of 6 and 10 minutes were also less than 49 atom counts/Zr.

### Example 7: UV Annealing Process Via a UV Chamber

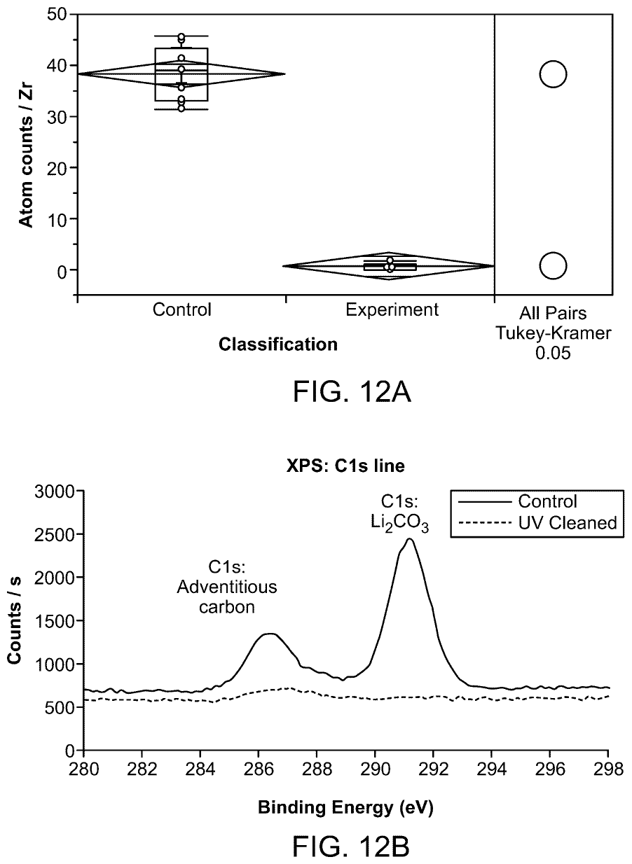

Lithium-stuffed garnet CSC films (66 mm×approximately 40 mm) were placed in a highly reflective UV-chamber (99% UV reflective). The lamp illumination was controlled via a programmable shutter. Residence time of the films were 12, 24, 36, or 72 minutes where UV tests were broken down into 12 minute cycles (the 12 minute run was one cycle; the 24 minute run was two cycles, etc.). The films were compared to a control that was not exposed to UV-light. After UV-treatment, the samples were bagged and vacuum-sealed for XPS analysis. The XPS analysis determined the amount of surface carbonate. As shown in FIG. 12A, the surface carbonate was reduced from 38.2 (±5.2) to 0.7 (±0.5) atom counts/Zr with the 72 minutes of UV-light. FIG. 12B is a one-way analysis comparing the surface carbonate and adventitious carbon of the film exposed to 72 minutes of UV-light and the control film. Both the carbonate levels and the adventitious carbon levels were calculated using the C1s binding energies. As shown in FIG. 12B, the film treated with UV-light had less carbonate and adventitious carbon on the surface.

### Example 8: N₂ Purge During UV Annealing Process

A UV-H light F300S μwave powdered electrodeless lamp (model P300 MT model) was mounted above a moving conveyor (LC6B benchtop conveyor with F300S lamp system installed) and installed in a large sample containment purge box. CSC films were irradiated with UV light in the chamber. The purge N₂ gas flow rate was varied and the amount of surface carbonate on the CSC films under each condition was analyzed by XPS. The results are shown in Table 1.

TABLE 1
The effect of N₂ purge flow rate on surface carbonate of films

| N₂ gas flow rate | |
|---|---|
| (Liters per minute) | Atom counts/Zr |
| 0 | 199.64 ± 20.80 |
| 1 | 25.95 ± 3.26 |
| 3 | 8.00 ± 1.37 |
| 5 | 5.51 ± 0.81 |

The film with no N₂ purge resulted in surface carbonate of approximately 200 atom counts/Zr, while a N₂ flow rate of 1 L/min, 3 L/min, and 5 L/min resulted in significantly less surface carbonate. As shown in Table 1, a N₂ flow rate of 5 L/min resulted in films with the least amount of surface carbonate.

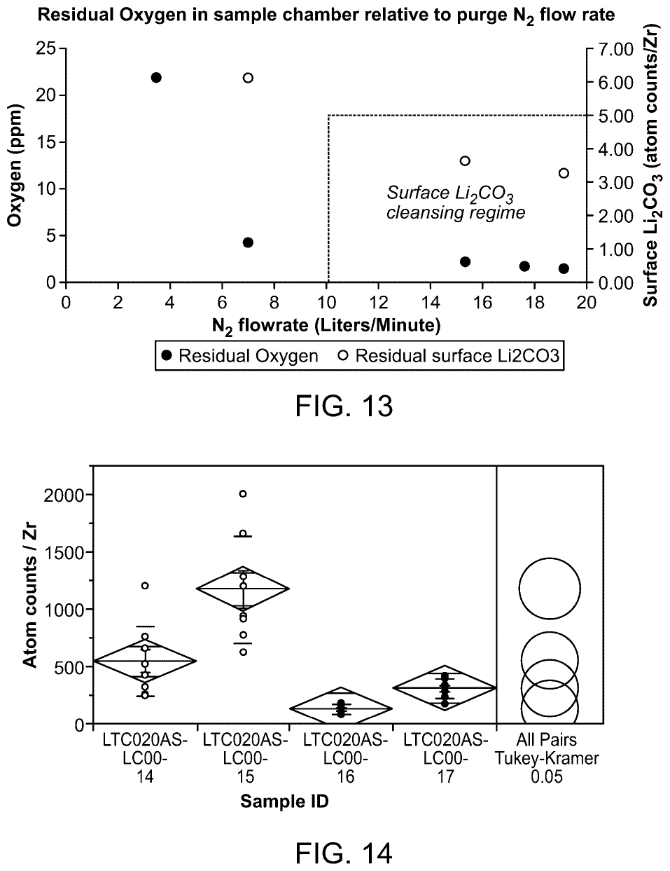

Various purge flow rates were also run on the sample containment box with UV and an oxygen analyzer connected at the exit of the purge box. Readings were taken following 1 minute of continuous purge and steady analyzer reading. FIG. 13 is a graph of the amount of oxygen relative to the purge N₂ flow rate. XPS results of residual garnet surface carbonate from films cleaned in a separate experiment at the flow rates analyzed were overlaid on the graph. As shown in the graph, a purge N₂ flow rate of approximately 10 L/min resulted in films with surface carbonate of less than about 5 atom counts/Zr. Importantly, a 10 L/min purge N₂ flow rate also resulted in residual oxygen levels of less than about 5 ppm.

### Example 9: Exposure Time of UV Annealing Process

A UV-H light F300S μwave powdered electrodeless lamp (model P300 MT model) was mounted above a moving conveyor (LC6B benchtop conveyor with F300S lamp system installed) and installed in a large sample containment purge box. The nitrogen purge flow was 15.3 L/min and CSC films were passed through the conveyor belt twice. The exposure time to the UV light was varied and the amount of surface carbonate on the CSC films was determined by XPS. The results are in Table 2. The surface carbonate of the film was measured at both the leading and trailing portion of the film to determine the continuity of the surface carbonate removal. As shown in Table 2, an exposure time of 60 seconds resulted in surface carbonate of less than 5 atom counts/Zr on both the trailing and leading portion of the film.

TABLE 2
The effect of UV-light exposure time on surface carbonate of films

| Exposure Time | Leading or Trailing | Atom counts/Zr |
|---|---|---|
| 30 seconds | Leading | 6.92 ± 0.20 |
| | Trailing | 8.01 ± 1.17 |
| 40 seconds | Leading | 6.18 ± 0.79 |
| | Trailing | 4.98 ± 0.26 |
| 60 seconds | Leading | 4.03 ± 0.52 |
| | Trailing | 4.16 ± 0.18 |
| 90 seconds | Leading | 5.25 ± 0.58 |
| | Trailing | 4.61 ± 0.29 |
| 120 seconds | Leading | 4.59 ± 0.33 |
| | Trailing | 4.71 ± 0.23 |

### Example 10: UV Annealing Process with Two Lamps

A F300S p wave powdered electrodeless lamp (model P300 MT model) with two UV-H light were mounted above a moving conveyor (LC6B benchtop conveyor with F300S lamp system installed) and installed in a large sample containment purge box. CSC films were irradiated with UV light in the chamber. The total power of the two lamps was varied and the amount of surface carbonate on the CSC films under each condition was determined by XPS. The results are in Table 3.

TABLE 3
The effect of total lamp power on surface carbonate of films

| Total Power (kW) | Atom counts/Zr |
|---|---|
| 6 | 6.34 ± 0.43 |
| 7 | 5.64 ± 0.56 |
| 8 | 5.34 ± 0.63 |
| 9 | 6.14 ± 0.58 |
| 12 | 5.94 ± 0.64 |

As shown in Table 3, the least residual surface carbonate was observed with a total power of 8 kW.

Next, the conveyer belt speed and the total power were varied to determine the effect on residual surface carbonate. The results are shown in Table 4. As shown in Table 4, the slower conveyer belt speed (5.6 mm/sec) combined with a total power of 7-8 kW resulted in the least amount of residual carbonate and highest uniformity of carbonate removal. In the graph, the surface carbonate was measured at the front and back of the leading and trailing portions of the film to study the uniformity of carbonate removal. The control is a sintered non-treated film.

TABLE 4
Surface carbonate of films exposed to UV-light at different UV power and conveyor speeds

| Mean | | | | | | Total | | | |
|---|---|---|---|---|---|---|---|---|---|
| Li₂CO₃ | | | | | | UV | Conveyor | | XPS |
| Atom | Std | | | | | Power | Speed | Purgebox | Sampling |
| Counts/Zr | Dev | Min | Max | Range | Median | (kW) | (mm/s) | Window | Location |
| 36.28 | 0.96 | 34.58 | 37.34 | 2.76 | 36.80 | 0 | Control | N/A | N/A |
| 6.25 | 0.32 | 5.77 | 6.62 | 0.85 | 6.37 | 6 | 5.6 | Lead | Back |
| 6.11 | 0.36 | 5.62 | 6.69 | 1.07 | 6.08 | 6 | 5.6 | Lead | Front |
| 6.16 | 0.37 | 5.65 | 6.65 | 1.00 | 6.13 | 6 | 5.6 | Trail | Back |
| 6.83 | 0.23 | 6.37 | 7.19 | 0.82 | 6.86 | 6 | 5.6 | Trail | Front |
| 4.98 | 0.11 | 4.83 | 5.16 | 0.33 | 4.98 | 7 | 5.6 | Lead | Back |
| 5.23 | 0.08 | 5.15 | 5.36 | 0.21 | 5.22 | 7 | 5.6 | Lead | Front |
| 6.15 | 0.11 | 5.95 | 6.29 | 0.34 | 6.13 | 7 | 5.6 | Trail | Back |
| 6.18 | 0.22 | 5.79 | 6.53 | 0.74 | 6.17 | 7 | 5.6 | Trail | Front |
| 5.97 | 0.22 | 5.64 | 6.32 | 0.68 | 5.99 | 8N | 5.6 | Lead | Back |
| 5.47 | 0.34 | 5.16 | 6.19 | 1.03 | 5.38 | 8N | 5.6 | Lead | Front |
| 4.43 | 0.31 | 3.93 | 4.90 | 0.97 | 4.40 | 8N | 5.6 | Trail | Back |
| 5.50 | 0.22 | 5.14 | 5.73 | 0.59 | 5.59 | 8N | 5.6 | Trail | Front |
| 7.63 | 0.21 | 7.42 | 8.13 | 0.71 | 7.62 | 8 S | 5.6 | Lead | Back |
| 7.57 | 0.14 | 7.36 | 7.72 | 0.36 | 7.61 | 8 S | 5.6 | Lead | Front |
| 9.43 | 0.13 | 9.17 | 9.58 | 0.41 | 9.43 | 8 S | 5.6 | Trail | Back |
| 11.80 | 6.20 | 7.95 | 22.99 | 15.05 | 9.09 | 8 S | 5.6 | Trail | Front |
| 5.75 | 0.38 | 5.34 | 6.33 | 0.99 | 5.61 | 9 | 5.6 | Lead | Back |
| 6.88 | 0.14 | 6.64 | 7.01 | 0.38 | 6.94 | 9 | 5.6 | Lead | Front |
| 5.63 | 0.21 | 5.39 | 5.99 | 0.60 | 5.57 | 9 | 5.6 | Trail | Back |
| 6.28 | 0.40 | 5.80 | 7.05 | 1.25 | 6.34 | 9 | 5.6 | Trail | Front |
| 6.83 | 0.59 | 5.71 | 7.53 | 1.82 | 7.02 | 12 | 5.6 | Lead | Back |
| 5.94 | 0.14 | 5.70 | 6.15 | 0.45 | 5.95 | 12 | 5.6 | Lead | Front |
| 5.62 | 0.13 | 5.41 | 5.81 | 0.40 | 5.60 | 12 | 5.6 | Trail | Back |
| 5.36 | 0.11 | 5.21 | 5.53 | 0.32 | 5.35 | 12 | 5.6 | Trail | Front |
| 7.55 | 0.64 | 6.80 | 8.61 | 1.81 | 7.45 | 12 | 6.4 | Lead | Back |
| 7.08 | 0.85 | 5.68 | 8.06 | 2.38 | 7.28 | 12 | 6.4 | Lead | Front |
| 8.97 | 0.26 | 8.38 | 9.27 | 0.90 | 9.04 | 12 | 6.4 | Trail | Back |
| 7.10 | 0.38 | 6.51 | 7.49 | 0.98 | 7.24 | 12 | 6.4 | Trail | Front |
| 8.82 | 0.21 | 8.49 | 9.10 | 0.61 | 8.89 | 12 | 10 | Lead | Back |
| 8.57 | 0.67 | 7.76 | 9.94 | 2.18 | 8.49 | 12 | 10 | Lead | Front |
| 9.01 | 0.29 | 8.58 | 9.50 | 0.91 | 9.03 | 12 | 10 | Trail | Back |
| 9.05 | 0.16 | 8.84 | 9.27 | 0.43 | 9.01 | 12 | 10 | Trail | Front |
| 34.72 | 5.43 | 25.00 | 40.88 | 15.88 | 36.38 | 12 | 40 | Lead | Back |
| 14.22 | 0.48 | 13.42 | 14.98 | 1.56 | 14.40 | 12 | 40 | Lead | Front |
| 22.98 | 3.62 | 18.72 | 28.51 | 9.78 | 21.52 | 12 | 40 | Trail | Back |
| 29.20 | 9.62 | 18.07 | 46.83 | 28.76 | 26.50 | 12 | 40 | Trail | Front |

### Example 11: UV Annealing Process with Slow Belt Speed

A F300S μwave powdered electrodeless lamp (model P300 MT model) with one UV-H light were mounted above a moving conveyor (LC6B benchtop conveyor with F300S lamp system installed) and installed in a large sample containment purge box. When the conveyer belt speed was slowed down to 2.5 mm/sec, the surface carbonate was less than 5 atoms count/Zr when low power (total low power of 6 kW) was also used (Table 5). This was observed with the FS300 and FS600 lamp.

TABLE 5
Surface carbonate of films exposed to UV-light at different
UV power and a conveyor speed of 2.5 mm/sec

| Mean | | | | | | | | |
|---|---|---|---|---|---|---|---|---|
| Li₂CO₃ | | | | | | | | XPS |
| Atom | Std | | | | | | | Sampling |
| Counts/Zr | Dev | Min | Max | Range | Median | Ptotal (kW) | Box Location | Location |
| 3.16 | 0.04 | 3.12 | 3.20 | 0.08 | 3.15 | 6 FS600 | 3 | Leading |
| 2.99 | 0.05 | 2.93 | 3.03 | 0.10 | 3.01 | 6 FS600 | 3 | Trailing |
| 3.32 | 0.33 | 2.95 | 3.60 | 0.65 | 3.41 | 6 FS600 | 4 | Leading |
| 3.59 | 0.21 | 3.38 | 3.79 | 0.41 | 3.59 | 6 FS600 | 4 | Trailing |
| 4.38 | 0.10 | 4.31 | 4.49 | 0.18 | 4.33 | 6 H | 3 | Leading |
| 4.50 | 0.08 | 4.40 | 4.55 | 0.15 | 4.54 | 6 H | 3 | Trailing |
| 3.62 | 0.06 | 3.57 | 3.68 | 0.11 | 3.59 | 6 H | 4 | Leading |
| 3.36 | 0.13 | 3.23 | 3.48 | 0.25 | 3.39 | 6 H | 4 | Trailing |
| 5.92 | 0.19 | 5.72 | 6.08 | 0.36 | 5.98 | 7 | 3 | Leading |
| 5.80 | 0.17 | 5.62 | 5.95 | 0.33 | 5.84 | 7 | 3 | Trailing |
| 4.84 | 0.26 | 4.58 | 5.11 | 0.53 | 4.83 | 7 | 4 | Leading |
| 5.05 | 0.00 | 5.05 | 5.06 | 0.01 | 5.05 | 7 | 4 | Trailing |
| 4.73 | 0.12 | 4.59 | 4.80 | 0.22 | 4.79 | 8 | 3 | Leading |
| 4.46 | 0.15 | 4.33 | 4.63 | 0.30 | 4.42 | 8 | 3 | Trailing |
| 4.09 | 0.13 | 3.96 | 4.22 | 0.27 | 4.09 | 8 | 4 | Leading |
| 4.34 | 0.05 | 4.29 | 4.39 | 0.09 | 4.32 | 8 | 4 | Trailing |
| 4.21 | 0.47 | 3.86 | 4.74 | 0.88 | 4.02 | 9 | 3 | Leading |
| 3.62 | 0.20 | 3.47 | 3.84 | 0.37 | 3.56 | 9 | 3 | Trailing |
| 4.78 | 0.14 | 4.61 | 4.87 | 0.26 | 4.85 | 9 | 4 | Leading |
| 4.98 | 0.19 | 4.82 | 5.19 | 0.38 | 4.94 | 9 | 4 | Trailing |
| 4.71 | 0.05 | 4.65 | 4.74 | 0.09 | 4.72 | 12 | 3 | Leading |
| 5.13 | 0.04 | 5.08 | 5.16 | 0.07 | 5.15 | 12 | 3 | Trailing |
| 3.85 | 0.23 | 3.65 | 4.10 | 0.45 | 3.79 | 12 | 4 | Leading |
| 3.51 | 0.16 | 3.34 | 3.66 | 0.32 | 3.52 | 12 | 4 | Trailing |

### Example 12: UV Treatment of Bilayers

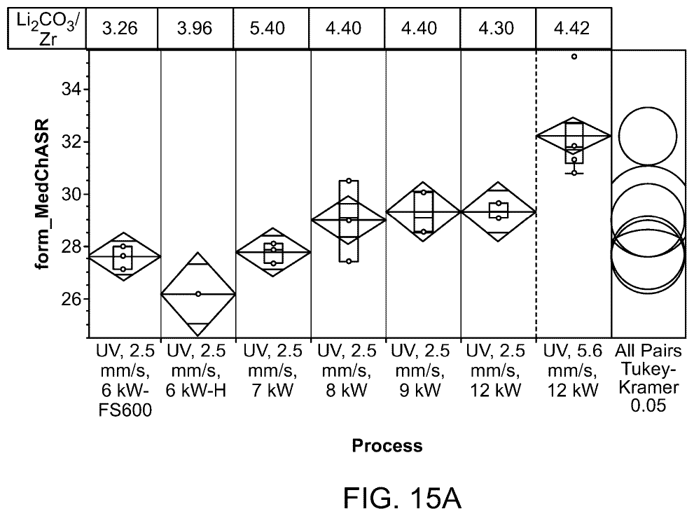

A UV-H light F300S μwave powdered electrodeless lamp (model P300 MT model) was mounted above a moving conveyor (LC6B benchtop conveyor with F300S lamp system installed) and installed in a large sample containment purge box. The nitrogen purge flow was 15.3 L/min and bilayers (film on metal foil) were passed through the conveyor belt twice. The amount of surface carbonate on the bilayers was determined by XPS. The results are in Table 6 and FIG. 14. The surface carbonate of the film was measured at both the leading and trailing portion of the film to determine the continuity of the surface carbonate removal.

TABLE 6
Surface carbonate of bilayers exposed to UV-light

| Sample ID | | Mean |
|---|---|---|
| Control (no UV) | LTC020AS-LC00-14 | 545.96 |
| | LTC020AS-LC00-15 | 1173.50 |
| UV treated, | LTC020AS-LC00-16 | 127.29 |
| leading & trailing | LTC020AS-LC00-17 | 311.22 |
| edges | | |

### Example 13: Median Charge and Discharge ASR

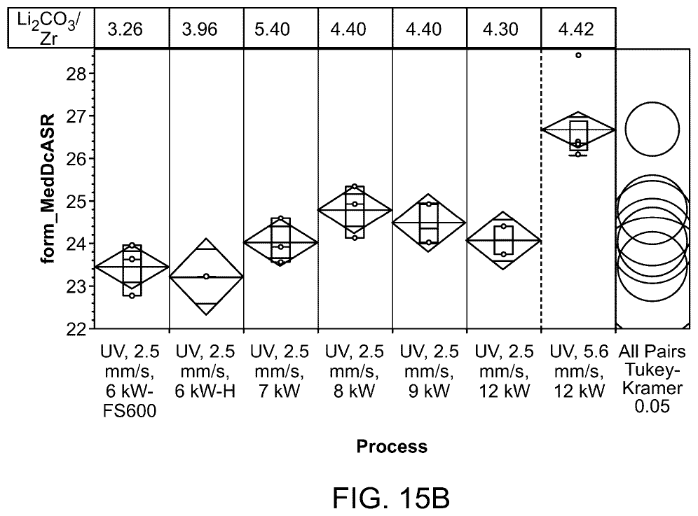

The median charge and discharge ASR of the CSC films exposed to UV-light in Example 11 were tested. The results are shown in FIG. 15A (charge) and FIG. 15B (discharge). As shown in FIG. 15A and FIG. 15B, a median charge and discharge ASR reduction was observed for all power combinations at the slower (2.5 mm/second) belt speed compared to the 5.6 mm/second belt speed. The median charge and discharge ASR for all powers at the 2.5 mm/second belt speed were less than 30 Ω-cm².

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. A process comprising: irradiating a bilayer with UV-light;
wherein the bilayer comprises a lithium-stuffed garnet layer disposed on a second layer;
wherein the second layer is selected from a metal layer or a co-sintered layer of lithium-stuffed garnet and a metal;
wherein the bilayer comprises a lithium-stuffed garnet layer disposed on metal foil comprising Nickel (Ni), Copper (Cu), Aluminum (Al), Iron (Fe), an alloy thereof, or a combination thereof; and
wherein the irradiating is in the presence of an inert atmosphere; a reducing atmosphere; or a low oxygen atmosphere.

2-6. (canceled)

7. The process of claim 1, wherein the bilayer is radiated with UV-light for less than about 10 minutes.

8-9. (canceled)

10. The process of claim 1, wherein the bilayer is radiated with UV-light for less than about 1 minute.

11. (canceled)

12. The process of claim 1, wherein the bilayer is radiated with UV-light while the bilayer is disposed on a conveyor belt and the conveyor belt moves at a conveyor speed between about 1 mm/second and 15 mm/second under the UV-light.

13. (canceled)

14. The process of claim 12, wherein the conveyor speed is about 2.5 mm/second.

15. The process of claim 1, wherein the UV-light has a wavelength range between 200 nm and 600 nm.

16. The process of claim 15, wherein the UV-light has a wavelength range of 250 nm.

17. The process of claim 16, wherein the bilayer is contacted with UV-light in the wavelength range between 200 nm and 600 nm in the presence of nitrogen for about 3 minutes.

18. The process of claim 1, wherein the bilayer is radiated with one UV-light lamp.

19. The process of claim 1, wherein the bilayer is radiated with two UV-light lamps.

20. The process of claim 18, wherein the combined total power of the UV-light lamp(s) is between about 6 and 12 kW.

21. The process of claim 12, wherein the bilayer is passed through the conveyer belt at least two times.

22. The process of claim 1, wherein the UV-light lamp height relative to the bilayer is the focal point of the UV-light lamp.

23. The process of claim 1, wherein the UV-light lamp height relative to the bilayer is about 5.8 cm.

24. The process of claim 1, wherein the bilayer is radiated with UV-light in the presence of an inert and low oxygen atmosphere wherein the oxygen level is less than about 5 ppm.

25. The process of claim 24, wherein the bilayer is radiated with UV-light in the presence of a continuous nitrogen purge to maintain an oxygen level below 5 ppm and the flow of the nitrogen purge is greater than about 5 L/min and less than 100 L/min.

26. (canceled)

27. The process of claim 12, wherein the conveyor speed is about 2.5 mm/second; the bilayer is passed through the conveyor belt at least two times; the bilayer is irradiated for less than 1 minute; the combined total power of the UV-light lamp(s) is 6 kW; the wavelength of the UV light is 250 nm; the height of the UV-lamp relative to the bilayer is 5.8 cm; and, the bilayer is radiated with UV-light in the presence of an inert nitrogen and low oxygen atmosphere wherein the oxygen level is less than about 5 ppm.

28-34. (canceled)

35. A process comprising: (a) contacting a bilayer with a plasma for less than about 10 minutes;
wherein the bilayer comprises a lithium-stuffed garnet layer disposed on a second layer;
wherein the second layer is selected from a metal layer or a co-sintered layer of lithium-stuffed garnet and a metal;
wherein the bilayer comprises a lithium-stuffed garnet layer disposed on metal foil comprising Nickel (Ni), Copper (Cu), Aluminum (Al), Iron (Fe), an alloy thereof, or a combination thereof;
wherein the contacting is in the presence of an inert atmosphere; a reducing atmosphere; or a low oxygen atmosphere; and
(b) heating the bilayer for less than about 10 minutes.

36. The process of claim 35, wherein the heating is in the presence of an inert atmosphere or a reducing atmosphere.

37-41. (canceled)

42. The process of claim 1, wherein the surface of the lithium-stuffed garnet layer of bilayer is characterized by a carbonate layer that has greater than about 50 atom counts/zirconium prior to a surface treatment and wherein the carbonate layer has less than about 10 atom counts/zirconium after the surface treatment.

43-62. (canceled)
